(19) United States
(12) Patent Application Publication
(10) Pub. No.: US 2023/0342703 A1
(43) Pub. Date: Oct. 26, 2023

(54) INFORMATION MANAGEMENT METHOD AND INFORMATION PROVIDING METHOD

(71) Applicant: DENSO CORPORATION, Kariya-city (JP)

(72) Inventors: TATSUYA OKABE, Kariya-city (JP); SATOSHI MIZUMA, Kariya-city (JP); SHINNOSUKE TANAKA, Kariya-city (JP)

(21) Appl. No.: 18/345,268

(22) Filed: Jun. 30, 2023

Related U.S. Application Data
(63) Continuation of application No. PCT/JP2021/048337, filed on Dec. 24, 2021.

(30) Foreign Application Priority Data
Jan. 6, 2021 (JP) 2021-000979
Dec. 23, 2021 (JP) 2021-209524

(51) Int. Cl. G06Q 10/0832

(52) U.S. Cl. CPC G06Q 10/0832

(57) ABSTRACT

An information management method, implemented by a computer, for managing information includes: acquiring a plurality of pieces of item information having different data input cycles or data measurement cycles as information associated with a specific item; and individually storing each of the plurality of pieces of item information associated with the specific item in association with a plurality of different blockchains.

### CROSS REFERENCE TO RELATED APPLICATIONS

This application is a continuation application of International Patent Application No. PCT/JP2021/048337 filed on Dec. 24, 2021, which designated the U.S. and claims the benefit of priority from Japanese Patent Application No. 2021-000979 filed on Jan. 6, 2021 and Japanese Patent Application No. 2021-209524 filed on Dec. 23, 2021. The entire disclosure of all the above applications is incorporated herein by reference.

### TECHNICAL FIELD

The disclosure according to this specification relates to an information management method for managing information and an information providing method for providing managed information.

### BACKGROUND ART

There have been known a monitoring method for cold chain delivery in which a plurality of parameters of a contract are measured continuously or at predetermined intervals by a shipping device associated with the contract, and measured parameters transmitted to a central location are stored in a database. As the plurality of parameters, for example, time data, temperature data, position data, and the like of the contract are stored in the database.

### SUMMARY

One aspect of the present disclosure is an information management method, implemented by a computer, for managing information. The method includes: acquiring a plurality of pieces of item information having different data input cycles or data measurement cycles as information associated with a specific item; and individually storing each of the plurality of pieces of item information associated with the specific item in association with a plurality of different blockchains.

### BRIEF DESCRIPTION OF DRAWINGS

FIG. 1 is a diagram illustrating an overall view of a cold chain management system according to a first embodiment of the present disclosure.

FIG. 2 is a diagram for explaining a flow of a cargo in a cold chain.

FIG. 3 is a diagram illustrating a detailed system configuration of the cold chain management system.

FIG. 4 is a block diagram illustrating an example of an electrical configuration of a user terminal and a staff terminal.

FIG. 5 is a diagram illustrating screen transition in a process of registering each piece of information in the staff terminal.

FIG. 6 is a sequence diagram illustrating details of cargo receiving processing performed at the time of receiving cargo.

FIG. 7 is a sequence diagram illustrating details of freezer association processing performed when a cargo is stored in a freezer.

FIG. 8 is a sequence diagram illustrating details of site processing performed in a site.

FIG. 9 is a sequence diagram illustrating details of cargo delivery processing performed at the time of cargo delivery.

FIG. 10 is a diagram illustrating transition of a screen for browsing cargo history information on the user terminal.

FIG. 11 is a sequence diagram illustrating details of information providing processing of providing cargo history information to the user terminal.

FIG. 12 is a sequence diagram illustrating details of advance notice processing of giving an advance notice of arrival of a cargo.

FIG. 13 is a view illustrating a display example of a transport route on a route display screen in Comparative Example 1.

FIG. 14 is a view illustrating a display example of a transport route on a route display screen in Comparative Example 2.

FIG. 15 is a view illustrating a display example of a transport route on a route display screen according to the present disclosure.

FIG. 16 is a diagram illustrating an outline of a supply chain according to a second embodiment of the present disclosure.

FIG. 17 is a diagram illustrating an overall view of a supply chain management system.

FIG. 18 is a diagram illustrating a detailed system configuration of the supply chain management system.

FIG. 19 is a sequence diagram illustrating details of a manufacturing usage amount storage processing of storing usage amount information of fuel and power used for manufacturing an item in a blockchain.

FIG. 20 is a sequence diagram illustrating details of sensor registration processing of associating an item with a monitoring device.

FIG. 21 is a sequence diagram illustrating details of registration cancellation processing for cancelling association between the item and the monitoring device.

FIG. 22 is a view illustrating screen transition in a case of referring to a carbon footprint using the user terminal or the like.

FIG. 23 is a view illustrating screen transition in a case of referring to a carbon footprint using a supplier terminal, a transporter terminal, and the like.

FIG. 24 is a diagram illustrating screen transition in a case where the carbon footprint of an item is browsed together with a transaction record.

FIG. 25 is a sequence diagram illustrating details of information providing processing of displaying the carbon footprint on each terminal.

FIG. 26 is a diagram for describing a concept of a packing unit of a cargo in which occurrence of re-packaging is assumed in a third embodiment of the present disclosure.

FIG. 27 is a diagram for explaining a flow of a cargo in the cold chain.

FIG. 28 is a diagram illustrating a detailed system configuration of the cold chain management system.

FIG. 29 is a diagram illustrating an example of information recorded in a manufacturer terminal.

FIG. 30 is a flowchart illustrating details of table preparation processing to be implemented by the manufacturer terminal.

FIG. 31 is a diagram illustrating an example of information recorded in a distributor terminal.

FIG. 32 is a sequence diagram illustrating details of re-packaging notification processing performed when re-packaging occurs.

FIG. 33 is a flowchart illustrating details of information registration processing to be implemented by a data processing server together with FIGS. 34 to 36.

FIG. 34 is a flowchart illustrating the details of the information registration processing together with FIGS. 33, 35, and 36.

FIG. 35 is a flowchart illustrating the details of the information registration processing together with FIGS. 33, 34, and 36.

FIG. 36 is a flowchart illustrating the details of the information registration processing together with FIGS. 33 to 35.

FIG. 37 is a diagram illustrating an example of data transmitted from the monitoring device to the data processing server.

FIG. 38 is a diagram illustrating an example of information managed by the data processing server.

FIG. 39 is a sequence diagram illustrating details of information providing processing of providing the cargo history information to the user terminal or the distributor terminal.

FIG. 40 is a diagram illustrating an example of data transmitted from the user terminal or the distributor terminal to the data processing server.

### DESCRIPTION OF EMBODIMENTS

Next, a relevant technology will be described first only for understanding the following embodiments. In a case where a plurality of types of measurement information associated with one item is collected in a database, these pieces of data can be targets for falsification. However, there have been no proposal for preventing falsification of data stored in the database.

One of objectives of the present disclosure is to provide a technology related to information management and information providing capable of reducing a falsification risk of information associated with an item.

A first aspect of the present disclosure is an information management method, implemented by a computer, for managing information. The method includes: acquiring a plurality of pieces of item information having different data input cycles or data measurement cycles as information associated with a specific item; and individually storing each of the plurality of pieces of item information associated with the specific item in association with a plurality of different blockchains.

A second aspect of the present disclosure is an information management method, implemented by a computer, for managing information related to a distribution item. The method includes: acquiring temperature measurement information repeatedly measured by a temperature sensor associated with the distribution item; acquiring position measurement information repeatedly measured by a position sensor associated with the distribution item; and storing the temperature measurement information and the position measurement information in association with at least one blockchain.

A third aspect of the present disclosure is an information management method, implemented by a computer, for managing information related to an item. The method includes: acquiring usage amount information indicative of a usage amount of power or an energy resource used in association with at least one of manufacturing and distributing of the item; and storing the usage amount information for each type of the power and the energy resource in association with at least one blockchain as the information related to the item.

A fourth aspect of the present disclosure is an information management method, implemented by a computer, for managing information related to a distribution item in a distribution process where re-packaging for dividing the distribution item into a plurality of distribution units is assumed to occur. The method includes: preparing association information for associating a pre-repackaging item that is the distribution item before the re-packaging with post-repackaging items that are the distribution item after the re-packaging; before the re-packaging occurs, storing first item information associated with the pre-repackaging item in association with a blockchain; and after the re-packaging occurred, individually storing second item information associated with each of the plurality of post-repackaging items in association with the blockchain.

In these aspects, information associated with the specific item or the distribution item is stored in association with the blockchain. Therefore, it is possible to reduce the falsification risk of the information associated with the item.

A fifth aspect of the present disclosure is an information providing method, implemented by a computer, for providing information managed by using a plurality of blockchains. The method includes: acquiring a providing request for information associated with a specific item; acquiring specific first information associated with the specific item from first information managed by a first blockchain; acquiring specific second information associated with the specific item from second information managed by a second blockchain different from the first blockchain; and generating providing data to be provided to a requesting source of the providing request by combining the specific first information and the specific second information.

A sixth aspect of the present disclosure is an information providing method, implemented by a computer, for providing information managed by using a blockchain. The method includes: acquiring usage amount information indicative of a usage amount of power or an energy resource used in relation to manufacturing and distributing of an item, the usage amount information being managed by the blockchain for each type of the power and the energy resource; preparing a calculation method in accordance with a destination set for the item; and calculating, using the prepared calculation method, a carbon release amount of the item from the usage amount information for each type of the power and the energy.

A seventh aspect of the present disclosure is an information providing method, implemented by a computer, for providing information managed by using a blockchain. The method includes: acquiring a providing request for information associated with a distribution item; when the distribution item are post-repackaging items that have been divided into a plurality of distribution units in a distribution process, referring to association information that associates a pre-repackaging item that is the distribution item before being divided into the plurality of distribution units with the post-repackaging items; acquiring first item information associated with the pre-repackaging item from the information managed using the blockchain together with second item information associated with the post-repackaging items; and generating providing data to be provided to a requesting source of the providing request by combining the first item information and the second item information.

Also in these aspects, information for generating providing data to be provided to a requesting source of a providing request or information for calculating a carbon release amount is managed using a blockchain. Therefore, it is possible to reduce the falsification risk of the information associated with the item.

Hereinafter, a plurality of embodiments will be described with reference to the drawings. Note that the same reference numerals are given to corresponding components in each embodiment, and redundant description may be omitted. When only a part of the configuration is described in each embodiment, the configuration of the other previously described embodiments can be applied to the other parts of the configuration. In addition, not only a combination of configurations explicitly described in the description of each embodiment but also configurations of a plurality of embodiments can be partially combined even if not explicitly described as long as there is no problem in the combination.

### First Embodiment

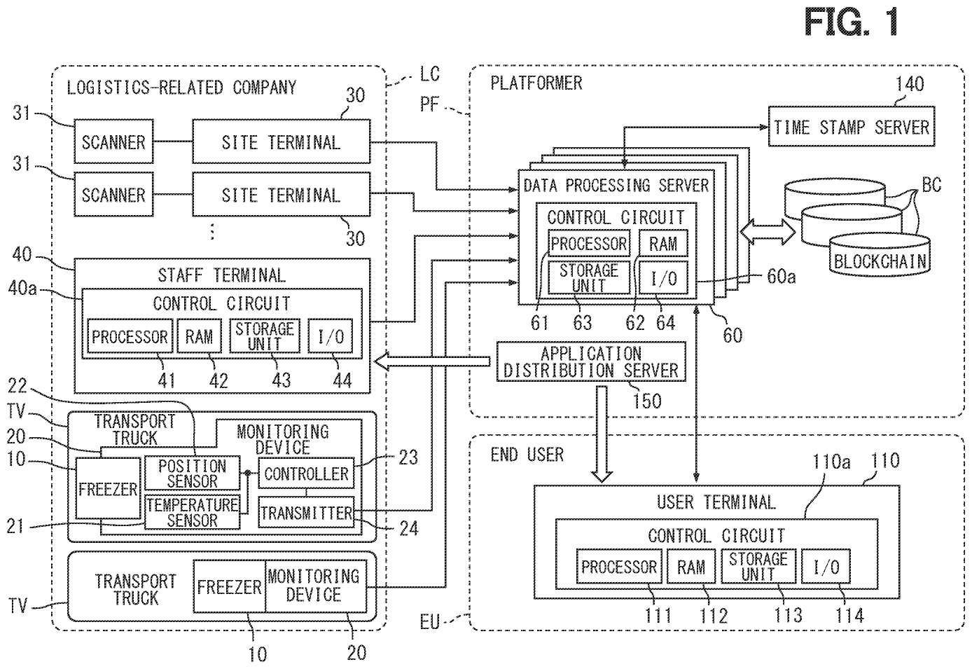

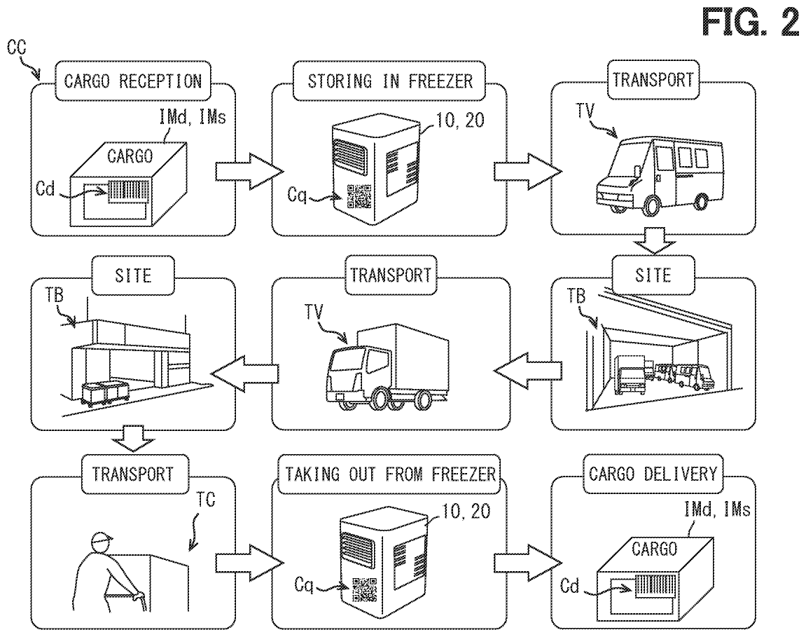

A cold chain management system according to a first embodiment of the present disclosure illustrated in FIG. 1 is an information management system applied to a cold chain CC illustrated in FIG. 2. The cold chain CC is a transport network for low-temperature distribution in which a specific item IMs such as a cargo IMd is delivered from a consignor to a consignee while being maintained in a low-temperature state. In the cold chain CC, the specific item IMs moves between a plurality of sites TB in a state of being accommodated in a cooler box provided with a freezer 10, or a refrigerator, and the like. The specific item IMs managed at a low temperature by the cold chain CC includes, for example, flowers and ornamental plants, medicines, chemicals, blood packs, and the like in addition to fresh food, marine products, frozen food, and the like.

As illustrated in FIGS. 1 and 2, by using a blockchain BC technology, the cold chain management system stores item information generated in a distribution process of the specific item IMs in the cold chain CC so as not to be falsified. The item information includes a large number of pieces of distribution information automatically or manually input in the distribution process, a plurality of types of sensor information measured by various sensors in the distribution process, and the like. The cold chain management system provides a large number of pieces of distribution information and a plurality of types of sensor information, which have been stored, to an end user EU or the like. The cold chain management system is constructed by a site terminal 30, a staff terminal 40, a monitoring device 20, and the like operated by a logistics-related company LC, and a plurality of server devices or the like managed by a platformer PF. Each element constituting the cold chain management system is connected to a network as one node.

The site terminal 30 is installed in each site TB operated by the logistics-related company LC. Each of the sites TB is a relay point where a transport facility for transporting the cargo IMd, for example, an aircraft, a ship, a railway, a transport truck TV, a carrier TC, and the like arrive and depart. In the site TB, a large number of cargos IMd carried in by one transport means are sorted and transferred from one freezer 10 to another freezer 10. The sorted cargos IMd are delivered from a specific transport means to another transport means and transported to another site TB.

An item code Cd in which an item ID is recorded is attached to each cargo IMd. The item ID is unique data for identifying the cargo IMd. The item ID may be a sequence of numbers or the like generated on the basis of a rule defined in advance, or may be a hash value or the like generated from data indicating a distribution history. In the cold chain management system, various types of information are managed in a format associated with the item ID. The item code Cd is a one-dimensional code such as a barcode or a two-dimensional code such as a QR code (registered trademark). The item code Cd is attached to an outer surface of the cargo IMd in a state of being printed on a paper medium or the like. An attachment place of the item code Cd is not limited to a product main body, and may be a package, a tag, a wrapping, a certificate, or the like. Furthermore, the item ID may be recorded as electronic data in a recording medium such as a radio frequency identifier (RFID) or a microchip attached to the cargo IMd.

The site terminal 30 grasps the cargo IMd carried into each site TB in respective sites TB. The site terminal 30 is communicably connected to a scanner 31 having a function of reading the item code Cd. The site terminal 30 acquires the item ID read from the item code Cd by the scanner 31. The site terminal 30 transmits the distribution information stored by the blockchain BC as one piece of item information associated with the cargo IMd to the server device (site information processing unit 81) of the platformer PF. Specifically, the site terminal 30 transmits, to the server device, site passage information including the item ID, a site ID for identifying each site TB, the reading time of the item code Cd, and the like as the distribution information related to the passage of the cargo IMd through the site TB. The information such as the site ID and the reading time may be manually input to the site terminal 30 by a worker or may be automatically input to the site terminal 30.

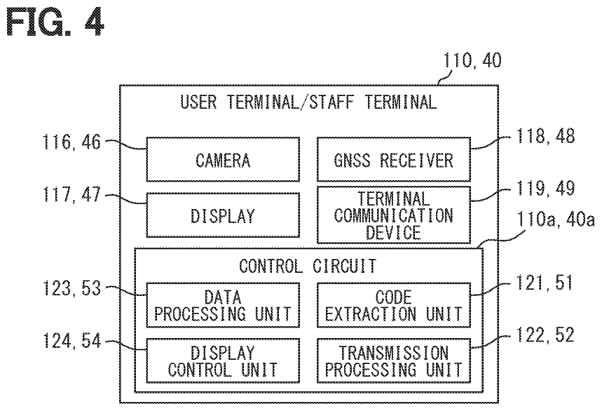

The staff terminal 40 functions as a history registration device that reads the item code Cd attached to the cargo IMd and registers a distribution history of the cargo IMd. Specifically, the staff terminal 40 registers records such as receipt of the cargo IMd from the consignor, loading and unloading of the cargo IMd into and from the freezer 10, and delivery of the cargo IMd to the consignee. As an example, a smartphone, a tablet terminal, a dedicated reading terminal, and the like possessed by a staff member or the like of the logistics-related company LC are used as the staff terminal 40. The staff terminal 40 includes a camera 46, a display 47, a global navigation satellite system (GNSS) receiver 48, a terminal communication device 49 (see FIG. 4), and a control circuit 40a.

The camera 46 generates imaging data of the item code Cd attached to the cargo IMd and a device code Cq (described later) attached to the freezer 10, and provides the imaging data to the control circuit 40a. The display 47 is a display device mainly including a liquid crystal panel, an organic EL panel, or the like. The display 47 displays various images on a screen under the control of the control circuit 40a. The display 47 has a function of a touch panel that receives a user operation.

The GNSS receiver 48 specifies the current position of the staff terminal 40 by receiving positioning signals transmitted from a plurality of artificial satellites (positioning satellites). The position data of the staff terminal 40 specified by the GNSS receiver 48 may be transmitted to the server device (front server 70) together with the reading time as history information indicating the place where the item code Cd or the device code Cq is read. The position data includes values such as latitude, longitude, and altitude estimated from the positioning signal. The terminal communication device 49 performs mobile communication conforming to a wide area wireless communication standard such as LTE and 5G, or a communication standard such as Wi-Fi (registered trademark).

The control circuit 40a includes a processor 41, a RAM 42, a storage unit 43, an input/output interface 44, a bus that connects these components, and the like, and functions as a computer that implements arithmetic processing. The processor 41 is hardware for arithmetic processing coupled with the RAM 42. The storage unit 43 stores an application program (hereinafter, an information registration application APr) for registering the information of the item code Cd and the device code Cq.

The monitoring device 20 is combined with the freezer 10 and mounted on the transport facility that transports the cargo IMd such as the transport truck TV. The freezer 10 is provided with the cooler box that accommodates the cargo IMd. The freezer 10 can maintain the temperature in the cooler box at a predetermined temperature (low temperature) set corresponding to the cargo IMd.

Each freezer 10 is provided with the device code Cq in which a cooler box ID is recorded. The cooler box ID is unique data for identifying the cooler box. The device code Cq is a one-dimensional code such as a barcode or a two-dimensional code such as a QR code. The device code Cq is attached to the outer surface or the like of the freezer 10 in a state of being printed on a paper medium or the like.

The monitoring device 20 is combined with the freezer 10 that accommodates the cargo IMd to repeatedly acquire measurement information associated with the cargo IMd. The monitoring device 20 transmits the acquired measurement information to the server device of the platformer PF sequentially or at regular time intervals. The monitoring device 20 may be physically integrated with the freezer 10, or may be provided separately from the freezer 10 and associated with a specific freezer 10 on data. The monitoring device 20 includes a temperature sensor 21, a position sensor 22, a controller 23, and a data transmitter 24.

The temperature sensor 21 periodically measures an ambient temperature in the cooler box. The temperature sensor 21 may have a contact type configuration using a thermocouple, a side temperature resistor, a thermistor, and the like, or may have a non-contact type configuration using a radiation thermometer or the like.

The position sensor 22 is a GNSS receiver that specifies the current position of the freezer 10 by receiving the positioning signals transmitted from the plurality of positioning satellites. The position sensor 22 periodically measures the current position of the freezer 10, in other words, the current positions of the cargo IMd and the transport truck TV during transport.

The controller 23 controls measurement of a physical quantity by the temperature sensor 21 and the position sensor 22. The controller 23 acquires temperature measurement information measured by the temperature sensor 21 and position measurement information measured by the position sensor 22. The controller 23 separately adjusts a measurement cycle of temperature measurement by the temperature sensor 21 and a measurement cycle of position measurement by the position sensor 22.

The controller 23 changes the measurement cycle of the temperature measurement information by the temperature sensor 21 on the basis of form information related to a form of the cargo IMd. The form information is information on the physical build, size, shape, and the like of the cargo IMd, and is specifically information on the volume, surface area, and the like. The controller 23 adjusts the cycle of temperature measurement to be longer as the surface area relative to the volume of the cargo IMd becomes smaller. The controller 23 adjusts the cycle of temperature measurement to be shorter as the surface area relative to the volume of the cargo IMd increases.

The controller 23 changes the measurement cycle of the position measurement information by the position sensor 22 on the basis of transport information related to transport. The transport information is speed information of the transport facility, type information of the transport facility, and the like. The controller 23 adjusts the cycle of position measurement to be shorter as the transport speed of the transport truck TV or the like increases, for example. The controller 23 adjusts the cycle of position measurement to be longer as the transport speed of the cargo IMd decreases. In addition, the controller 23 adjusts the cycle of position measurement to be longer in a case where the cargo IMd is transported by the transport facility that linearly moves such as the aircraft or the ship, on the basis of the type information of the transport facility. The controller 23 adjusts the cycle of position measurement to be shorter in a case where the cargo IMd is transported by the transport facility that moves non-linearly such as the transport truck TV.

Here, each measurement cycle of the temperature sensor 21 and the position sensor 22 corresponds to an acquisition cycle of measurement information transmitted to a data processing server 60 by the controller 23 and the data transmitter 24. That is, the actual measurement cycle in the temperature sensor 21 and the position sensor 22 may be shorter than the measurement cycle on the record accumulated in the data processing server 60. In other words, the controller 23 may adjust the measurement cycle (acquisition cycle) of the temperature measurement information and the position measurement information by processing of thinning out the actual measurement information.

The data transmitter 24 performs mobile communication conforming to a wide area wireless communication standard such as LTE and 5G, or a communication standard such as Wi-Fi (registered trademark). The data transmitter 24 can communicate with the server device of the platformer PF. The data transmitter 24 coordinates with the controller 23 to transmit the temperature measurement information repeatedly measured by the temperature sensor 21 to the server device (temperature information processing unit 84) of the platformer PF. Similarly, the data transmitter 24 coordinates with the controller 23 to transmit the position measurement information repeatedly measured by the position sensor 22 to the server device (position information processing unit 87) of the platformer PF. A transmission cycle of the temperature measurement information and the measurement cycle of the position measurement information may be different from each other. A sensor ID for identifying the monitoring device 20 is associated with the temperature measurement information and the position measurement information. In the present embodiment, the cooler box ID also serves as the sensor ID. The data transmitter 24 uploads the temperature measurement information and the position measurement information associated with the cooler box ID to the server device.

As illustrated in FIGS. 1 to 3, the server device managed by the platformer PF includes a plurality of data processing servers 60, a time stamp server 140, and an application distribution server 150.

The data processing server 60 can communicate with a large number of monitoring devices 20, a large number of site terminals 30, and a large number of staff terminals 40 through a network. The data processing server 60 functions as an information management device that manages information related to the cargo IMd and an information providing device that provides information related to the cargo IMd.

The data processing server 60 is a server device mainly including a control circuit 60a that functions as a computer. The control circuit 60a of the data processing server 60 includes a processor 61, a RAM 62, a storage unit 63, an input/output interface 64, a bus connecting these, and the like. The processor 61 is hardware for arithmetic processing coupled with the RAM 62. The processor 61 executes various processing related to management and providing of data by accessing the RAM 62. The storage unit 63 stores an information management program that realizes a function related to data management and an information providing program that realizes a function related to data provision. The information management program is a program for causing the data processing server 60 to implement the information management method of the present disclosure. The information providing program is a program for causing the data processing server 60 to implement the information providing method of the present disclosure.

In the cold chain management system, the plurality of data processing servers 60 having different functions are used. In the present embodiment, the front server 70, a plurality of (three) information relay servers 80, and a plurality of (three) blockchain servers 90 are provided as the data processing servers 60.

The front server 70 is the data processing server 60 that communicates with the staff terminal 40 and a user terminal 110 (described later). The front server 70 includes a cargo information processing unit 71, a temperature information processing unit 72, a position information processing unit 73, a request acceptance unit 75, and a data providing unit 76 as functional units based on the information management program and the information providing program.

The cargo information processing unit 71 acquires the item ID of the received cargo IMd by reception from the staff terminal 40, and transmits the item ID to the information relay server 80 (site information processing unit 81) as cargo receipt information. The cargo information processing unit 71 acquires the site passage information, the cargo receipt information, delivery information, and the like associated with the item ID from the information relay server 80 (site information processing unit 81).

The temperature information processing unit 72 receives, from the staff terminal 40, sensor coordination information that associates the item ID of the cargo IMd with the cooler box ID of the freezer 10 that accommodates the cargo IMd. The temperature information processing unit 72 transmits the acquired sensor coordination information to the information relay server 80 (temperature information processing unit 84). The temperature information processing unit 72 acquires the sensor coordination information and the temperature measurement information associated with the item ID from the information relay server 80 (temperature information processing unit 84).

The position information processing unit 73 acquires the temperature measurement information associated with the item ID from the information relay server 80 (position information processing unit 87). Note that, similar to the temperature information processing unit 72, the position information processing unit 73 may transmit the sensor coordination information received from the staff terminal 40 to the information relay server 80 (position information processing unit 87).

The request acceptance unit 75 acquires the providing request of the history information associated with the cargo IMd from the staff terminal 40 or the user terminal 110 together with the item ID. The request acceptance unit 75 requests the information relay server 80 and the blockchain server 90 to provide the site passage information, the temperature measurement information, the position measurement information, and the like associated with the item ID through each information processing unit 71 to 73.

The data providing unit 76 grasps the site passage information, the temperature measurement information, and the position measurement information collected by the cargo information processing unit 71, the temperature information processing unit 72, and the position information processing unit 73 on the basis of the providing request. The data providing unit 76 combines the site passage information, the temperature measurement information, and the position measurement information to generate providing data to be provided to a requesting source of the providing request. The data providing unit 76 transmits the generated providing data to the staff terminal 40 or the user terminal 110.

The information relay server 80 receives information transmitted from the monitoring device 20 and the staff terminal 40, and transmits the information to the blockchain server 90. The information relay server 80 relays the providing request transmitted to the front server 70, and returns the information extracted by the blockchain server 90 to the front server 70. Three information relay servers 80 are provided in the cold chain management system. The information relay servers 80 are provided with information processing units 81, 84, and 87, respectively, as functional units based on the information management program and the information providing program.

The information relay server 80 that processes the site passage information includes the site information processing unit 81. The site information processing unit 81 acquires the item ID of the received cargo IMd from the cargo information processing unit 71, and transmits the item ID to the blockchain server 90 that accumulates site passage information. The site information processing unit 81 receives the site passage information from the site terminal 30 and transmits the site passage information to the blockchain server 90 that accumulates the site passage information. The site information processing unit 81 receives the site passage information or the like extracted by the blockchain server 90 and transmits the site passage information or the like to the cargo information processing unit 71.

The information relay server 80 that processes the temperature measurement information includes the temperature information processing unit 84. The temperature information processing unit 84 transmits the sensor coordination information received from the staff terminal 40 and the temperature measurement information received from the monitoring device 20 to the blockchain server 90 that accumulates the temperature measurement information. The temperature information processing unit 84 receives the temperature measurement information or the like extracted by the blockchain server 90, and transmits the temperature measurement information or the like to the temperature information processing unit 72.

The information relay server 80 that processes the position measurement information includes the position information processing unit 87. The position information processing unit 87 transmits the position measurement information received from the monitoring device 20 to the blockchain server 90 that accumulates the position measurement information. The position information processing unit 87 receives the position measurement information or the like extracted by the blockchain server 90, and transmits the position measurement information or the like to the position information processing unit 73.

The blockchain server 90 manages information received from the information relay server 80 using the blockchain BC. The blockchain server 90 transmits information managed using the blockchain BC to the information relay server 80 in order to provide the information to the end user EU or the like. The blockchain BC used in the blockchain server 90 may be a private chain managed by the platformer PF, or may be a public chain in which an unspecified number of participants can accumulate data. The blockchain server 90 can use the public chain such as Ethereum, Bitcoin, and NEM for accumulating information.

The cold chain management system is provided with three blockchain servers 90. Each blockchain server 90 stores the acquired information in association with the blockchain BC. The processing of storing in association with the blockchain BC may be a storing processing of embedding original data of the acquisition information in the block of the blockchain BC, or may be a storing processing of embedding a hash value generated from the original data of the acquisition information in the block of the blockchain BC. The blockchain servers 90 include information acquisition units 91, 94, and 97, information storing units 92, 95, and 98, and information providing units 93, 96, and 99, respectively, as functional units based on the information management program and the information providing program.

The blockchain server 90 that manages the site passage information includes a site information acquisition unit 91, a site information storing unit 92, and a site information providing unit 93. The site information acquisition unit 91 acquires the item ID, the site passage information, and the like from the site information processing unit 81. The site information storing unit 92 stores the information acquired by the site information acquisition unit 91 in association with a site information keeping chain BC1. The site information storing unit 92 registers the site passage information and the like in association with the item ID. As a result, time data, position data, and the like of receiving, passing through the site, and delivery of each cargo IMd are recorded in the site information keeping chain BC1.

The site information providing unit 93 extracts information associated with the item ID from the information accumulated in the site information keeping chain BC1 using the item ID as a key. The site information providing unit 93 provides the extracted site passage information, cargo receipt information, delivery information, and the like to the site information processing unit 81.

The blockchain server 90 that manages temperature measurement information includes a temperature information acquisition unit 94, a temperature information storing unit 95, and a temperature information providing unit 96. The temperature information acquisition unit 94 acquires, from the temperature information processing unit 84, sensor coordination information including the item ID and the cooler box ID, and temperature measurement information associated with the cooler box ID. The temperature measurement information is a data group in which a combination of measurement time data and a measured temperature value is set as one piece of data. The temperature information storing unit 95 stores each piece of information acquired by the temperature information acquisition unit 94 in a temperature information keeping chain BC2. By storing the sensor coordination information, the temperature measurement information is accumulated in the temperature information keeping chain BC2 in a state where the temperature measurement information can be associated with the item ID.

The temperature information providing unit 96 extracts temperature measurement information associated with the item ID from the temperature measurement information accumulated in the temperature information keeping chain BC2 by using the item ID and the sensor coordination information. In a case where the cargo IMd passes through the plurality of cooler boxes, the temperature information providing unit 96 extracts a series of pieces of temperature measurement information associated with the item ID by cutting out data of a period in which the cargo IMd has been accommodated from the plurality of pieces of temperature measurement information associated with individual cooler box IDs. The temperature information providing unit 96 provides the extracted temperature measurement information to the temperature information processing unit 84.

The blockchain server 90 that manages the position measurement information includes a position information acquisition unit 97, a position information storing unit 98, and a position information providing unit 99. The position information acquisition unit 97 acquires position measurement information associated with the cooler box ID from the position information processing unit 87. The position measurement information is a data group in which a combination of the measurement time data and the position data is set as one piece of data. The position data is, for example, coordinate values indicating latitude, longitude, and altitude. The position information storing unit 98 stores the information acquired by the position information acquisition unit 97 in a position information keeping chain BC3.

The position information providing unit 99 extracts position measurement information associated with the item ID from the information accumulated in the position information keeping chain BC3 using the cooler box ID as a key. In a case where the cargo IMd passes through the plurality of cooler boxes, the position information providing unit 99 extracts a series of position measurement information from the cargo receipt to the delivery by cutting out data of the same period as that of the temperature information providing unit 96 from the plurality of pieces of position measurement information associated with each cooler box ID. The position information providing unit 99 provides the extracted position measurement information to the position information processing unit 87.

The time stamp server 140 is a server device mainly including a computer. The time stamp server 140 generates time stamp data to be provided to the data processing server 60. As an example, the time stamp server 140 acquires a news article distributed in association with information indicating date and time from a news distribution server or the like connected to the network every day or every predetermined time. The time stamp server 140 generates, from the acquired news article, input information in which date information, a character string of the news article, and a character string designated in advance are sequentially combined. The time stamp server 140 generates a hash value of a predetermined number of bits (for example, 256 bits) as time stamp data by processing of inputting input information to a hash function such as SHA-256. The time stamp data is provided to each blockchain server 90, for example, and is stored in each blockchain BC as data that can verify the presence or absence of falsification of the acquisition time, the storage time, and the like of each piece of information.

The application distribution server 150 is a server device mainly including a computer. The application distribution server 150 distributes an information registration application APr, a log browsing application APb (to be described later), an arrival advisory application APa (to be described later), and the like through the network. The information registration application APr is downloaded from the application distribution server 150 to the storage unit 43 of the staff terminal 40, and is automatically installed in the staff terminal 40 after completion of the download. The log browsing application APb and the arrival advisory application APa are downloaded from the application distribution server 150 to a storage unit 113 of the user terminal 110, and are automatically installed in the user terminal 110 after completion of the download.

Note that the application distribution server 150 need not be a server device managed by the platformer PF. The application distribution server 150 may be, for example, a server device managed by a vendor of an operating system of the staff terminal 40 and the user terminal 110.

The end user EU can refer to the history information of the cargo IMd managed by the above cold chain management system by using the user terminal 110 illustrated in FIGS. 1, 3, and 4. The user terminal 110 is a smartphone, a tablet terminal, a dedicated reading terminal, or the like owned by the user. The user terminal 110 includes a camera 116, a display 117, a GNSS receiver 118, a terminal communication device 119, and a control circuit 110a. The control circuit 110a includes a processor 111, a RAM 112, the storage unit 113, an input/output interface 114, a bus that connects these components, and the like, and functions as a computer that implements arithmetic processing. Each configuration of the user terminal 110 described above is substantially the same as each configuration of the staff terminal 40 described above.

The storage unit 113 of the user terminal 110 stores the above-described log browsing application APb as an application program for referring to the history information of the cargo IMd. The user terminal 110 functions as an information browsing apparatus by the processor 111 executing the log browsing application APb. The user terminal 110 includes a code extraction unit 121, a transmission processing unit 122, a data processing unit 123, and a display control unit 124 as functional units based on the log browsing application APb. Similarly, the staff terminal 40 includes a code extraction unit 51, a transmission processing unit 52, a data processing unit 53, and a display control unit 54 as functional units based on the information registration application APr.

In the user terminal 110 and the staff terminal 40, the code extraction units 121 and 51 acquire the imaging data of the item code Cd and the device code Cq captured by the cameras 116 and 46. The code extraction units 121 and 51 extract the item ID and the cooler box ID by image analysis of the imaging data.

The transmission processing units 122 and 52 transmit at least one of the item ID and the cooler box ID extracted by the code extraction units 121 and 51 to the front server 70. The transmission processing units 122 and 52 transmit the history information providing request based on the user operation to the front server 70.

The data processing units 123 and 53 acquire the providing data returned from the front server 70 on the basis of the providing request. The display control units 124 and 54 cause the displays 117 and 47 to display scan screens GA5, GA6, and the like for reading the item code Cd and the device code Cq. The display control units 124 and 54 display a log browsing screen on the displays 117 and 47 on the basis of the providing data processed by the data processing units 123 and 53.

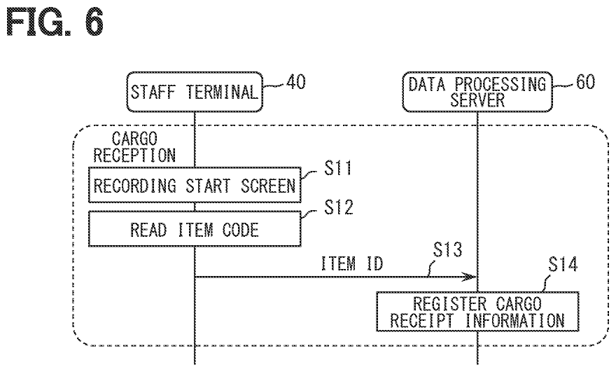

Next, details of cargo receiving processing, freezer association processing, site processing, and cargo delivery processing for accumulating the history information of the cargo IMd in the cold chain management system will be described below on the basis of FIGS. 6 to 9 and with reference to FIGS. 1 to 5.

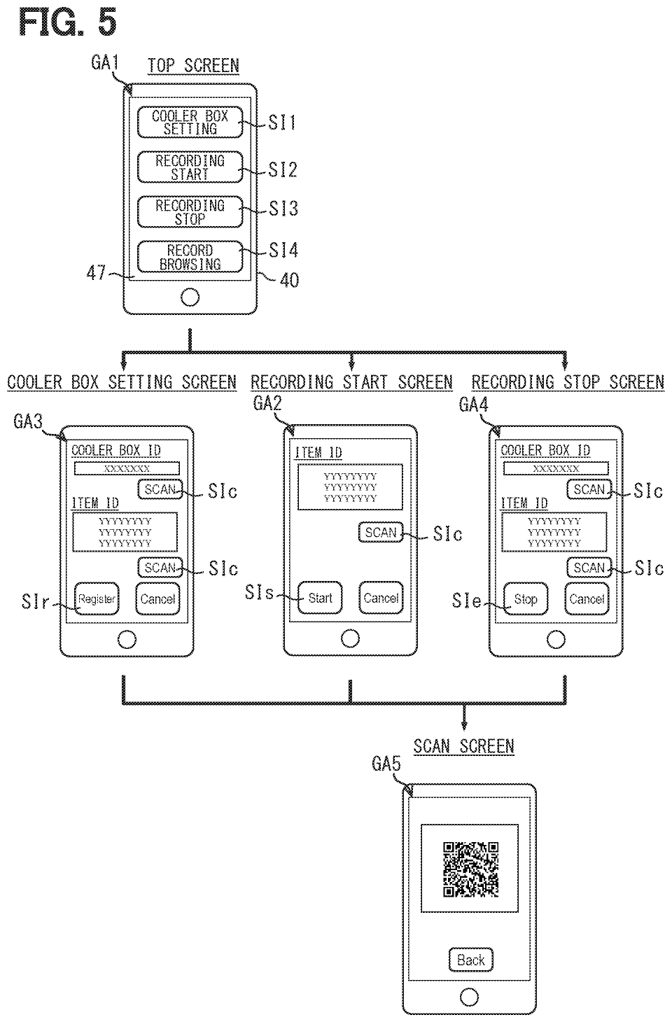

The cargo receiving processing illustrated in FIG. 6 is implemented by the staff terminal 40 and the data processing server 60 in a cargo receiving step (see FIG. 2) in which the staff member of the logistics-related company LC keeps the cargo IMd from the consignor. The staff terminal 40 displays a top screen GA1 (see FIG. 5) on the display 47 on the basis of the input of the operation of starting the information registration application APr. A plurality of selection icons SI1 to SI4 is displayed on the top screen GA1.

The staff terminal 40 shifts the display of the display 47 from the top screen GA1 to a recording start screen GA2 (see FIG. 5) on the basis of the tap operation on the selection icon SI2 (S11). The recording start screen GA2 is an interface screen for registering the start of recording of the history information associated with the cargo IMd in the data processing server 60. On the recording start screen GA2, a scan icon SIc, a start icon SIs, a cancel icon, and the like are displayed. The staff terminal 40 shifts the display of the display 47 to the scan screen GA5 (see FIG. 5) on the basis of the tap operation on the scan icon SIc. The staff terminal 40 reads the item code Cd captured on the scan screen GA5 and acquires the item ID (S12).

On the basis of the tap operation on the start icon SIs (see FIG. 5), the staff terminal 40 transmits read item ID to the data processing server 60 together with the current time (ID reading time), the position data, and the like (S13). In the data processing server 60, the cargo receipt information including the item ID or the like is registered in the site information keeping chain BC1 by the coordination of the cargo information processing unit 71, the site information processing unit 81, the site information acquisition unit 91, and the like (S14).

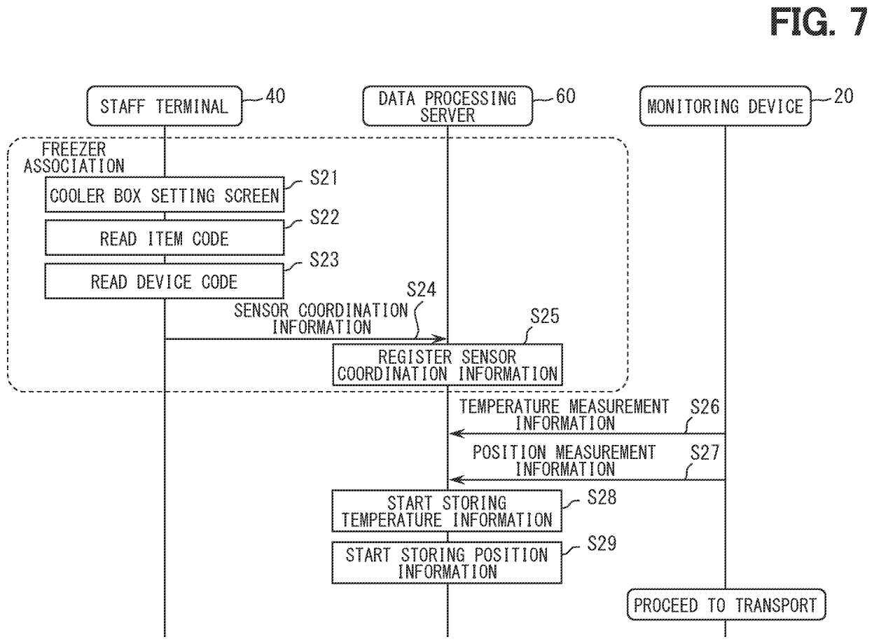

The freezer association processing illustrated in FIG. 7 is implemented in a step (see FIG. 2) of storing the cargo IMd in the cooler box of the freezer 10 immediately after receiving the cargo from the consignor or at each site TB. The freezer association processing is implemented by the staff terminal 40 and the data processing server 60.

The staff terminal 40 displays a cooler box setting screen GA3 (see FIG. 5) on the display 47 on the basis of the tap operation on the selection icon SI1 (see FIG. 5) on the top screen GA1 (S21). The cooler box setting screen GA3 is an interface screen for registering the sensor coordination information for associating the item ID with the cooler box ID in the data processing server 60. On the cooler box setting screen GA3, two scan icons SIc, a registration icon SIr, a cancel icon, and the like are displayed (see FIG. 5).

The staff terminal 40 reads the item code Cd of the cargo IMd stored in the cooler box on the scan screen GA5 and acquires the item ID (S22). Furthermore, the staff terminal 40 reads the device code Cq of the cooler box for accommodating the cargo IMd on the scan screen GA5, and acquires the cooler box ID (S23). On the basis of the tap operation of the registration icon SIr (see FIG. 5), the staff terminal 40 transmits the sensor coordination information including the acquired item ID and the cooler box ID to the data processing server 60 together with the current time (ID reading time) or the like (S24).

In the data processing server 60, the sensor coordination information is registered in the temperature information keeping chain BC2 by the coordination of the temperature information processing units 72 and 84, the temperature information acquisition unit 94, and the like (S25). Furthermore, the temperature information processing unit 84 and the position information processing unit 87 are notified of the cooler box ID of the monitoring device 20 that starts uploading each piece of measurement information. Thus, the freezer association processing is completed. As a result, transmission of the temperature measurement information from the monitoring device 20 to the temperature information acquisition unit 94 (S26) and transmission of the position measurement information from the monitoring device 20 to the position information acquisition unit 97 (S27) are started.

As described above, the temperature information acquisition unit 94 and the position information acquisition unit 97 start receiving the temperature measurement information repeatedly measured by the temperature sensor 21 associated with the cargo IMd and the position measurement information repeatedly measured by the position sensor 22 associated with the cargo IMd. The temperature information acquisition unit 94 and the position information acquisition unit 97 acquire temperature measurement information and position measurement information that are item information associated with the cargo IMd and have different measurement cycles.

The temperature information storing unit 95 starts storing the temperature measurement information transmitted by the monitoring device 20 in the temperature information keeping chain BC2 (S28). Similarly, the position information storing unit 98 starts storing the position measurement information transmitted by the monitoring device 20 in the position information keeping chain BC3 (S29). As described above, the temperature measurement information and the position measurement information are individually stored in association with the plurality of different blockchains BC.

The monitoring device 20 is transported by the transport truck TV or the like while continuing data transmission to the data processing server 60. As a result, the temperature information acquisition unit 94 acquires temperature measurement information (in-transport temperature data) measured by the temperature sensor 21 associated with the cargo IMd during the transportation period of time in which the cargo IMd moves between the sites TB. Similarly, the position information acquisition unit 97 acquires position measurement information (in-transport position data) measured by the position sensor 22 associated with the cargo IMd during the transportation period of time of the cargo IMd.

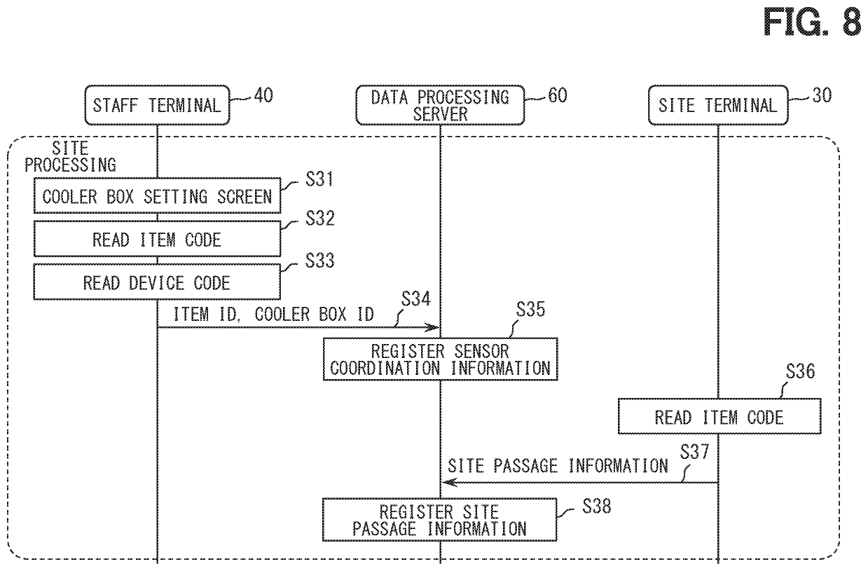

The site processing illustrated in FIG. 8 is implemented in a step of taking out the cargo IMd from the freezer 10 of the transport facility at each site TB. The site processing is implemented by the staff terminal 40, the data processing server 60, and the site terminal 30.

Similar to the case of implementing the freezer association processing, the staff terminal 40 displays the cooler box setting screen GA3 on the basis of the tap operation of the staff (S31). The staff terminal 40 reads the item code Cd of the cargo IMd taken out from the cooler box on the scan screen GA5 and acquires the item ID (S32). Furthermore, the staff terminal 40 reads the device code Cq of the cooler box from which the cargo IMd has been taken out on the scan screen GA5, and acquires the cooler box ID (S33). On the basis of the tap operation of the registration icon SIr (see FIG. 5), the staff terminal 40 transmits the acquired item ID and the cooler box ID to the data processing server 60 together with the current time (ID reading time) or the like (S34).

In the data processing server 60, the sensor coordination information for canceling association between the cargo IMd and the cooler box is registered in the temperature information keeping chain BC2 by the coordination among the temperature information processing units 72 and 84, the temperature information acquisition unit 94, and the like (S35).

The site terminal 30 reads the item code Cd of the cargo IMd taken out from the cooler box in the site TB by the scanner 31 to acquire the item ID (S36). The site terminal 30 transmits the site passage information including the acquired item ID, the site ID set in advance, the current time (site passage time), and the like to the data processing server 60 (S37).

In the data processing server 60, site passage information indicating the current passage through the site TB is registered in the site information keeping chain BC1 by the coordination of the cargo information processing unit 71, the site information processing unit 81, the site information acquisition unit 91, and the like (S38).

The cargo IMd sorted at the site TB is accommodated in the cooler box of the next transport facility. Through the freezer association processing (see FIG. 7) to be implemented at this time, the item ID of the cargo IMd is associated with the cooler box ID of the next freezer 10.

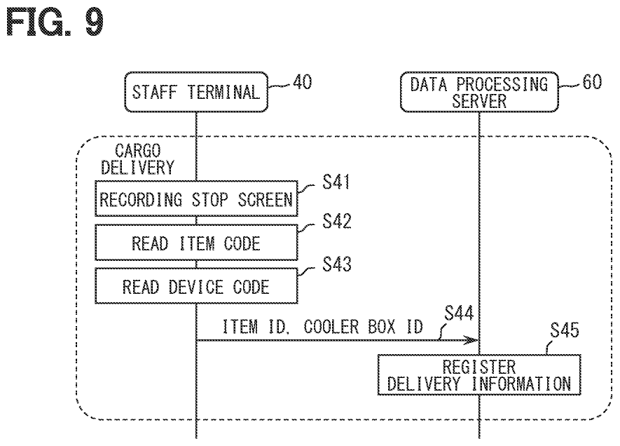

The cargo delivery processing illustrated in FIG. 9 is implemented by the staff terminal 40 and the data processing server 60 in a step in which the staff member of the logistics-related company LC delivers the cargo IMd to the consignee (see FIG. 2).

The staff terminal 40 shifts the display of the display 47 from the top screen GA1 to a recording stop screen GA4 (see FIG. 5) on the basis of the tap operation on the selection icon SI3 (see FIG. 5) (S41). The recording stop screen GA4 is an interface screen for registering the end of recording of the history information associated with the cargo IMd in the data processing server 60. On the recording stop screen GA4, the scan icons SIc, a stop icon Sle, the cancel icon, and the like are displayed.

The staff terminal 40 reads the item code Cd of the cargo IMd taken out from the cooler box on the scan screen GA5 shifted from the recording stop screen GA4, and acquires the item ID (S42). Furthermore, the staff terminal 40 reads the device code Cq of the cooler box from which the cargo IMd has been taken out on the scan screen GA5, and acquires the cooler box ID (S43). On the basis of the tap operation on the stop icon Sle (see FIG. 5), the staff terminal 40 transmits the read item ID and cooler box ID to the data processing server 60 together with the current time (ID reading time), the position data, and the like (S44).

In the data processing server 60, the delivery information of the cargo IMd is registered in the site information keeping chain BC1 by the coordination of the cargo information processing unit 71, the site information processing unit 81, the site information acquisition unit 91, and the like (S45). As described above, a series of processing of accumulating the history information in the distribution process for one cargo IMd in each blockchain BC is completed.

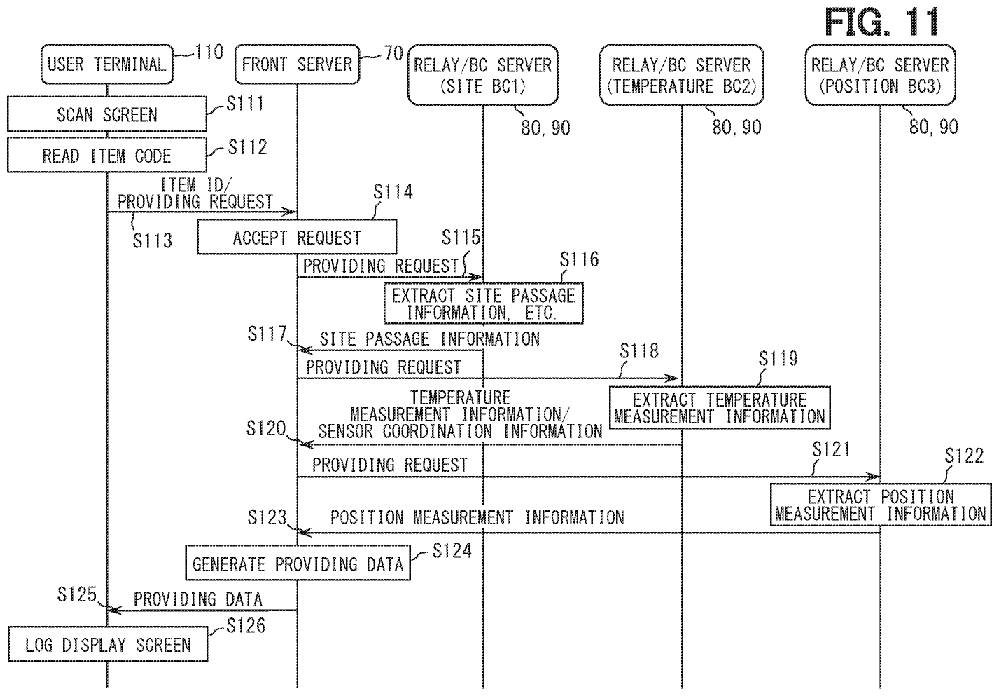

Next, details of information providing processing of providing the history information of the cargo IMd accumulated in the cold chain management system to the user terminal 110 or the staff terminal 40 will be described below on the basis of FIG. 11 and with reference to FIGS. 10 and FIGS. 1 to 4.

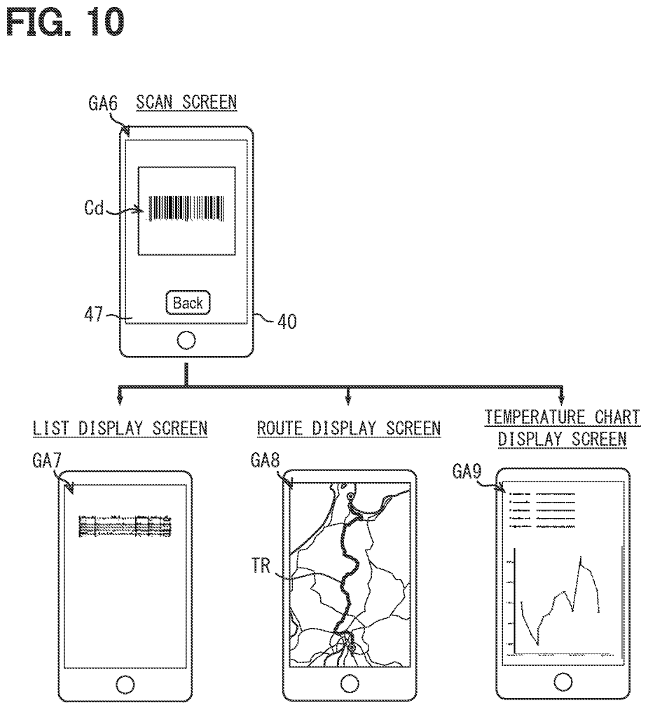

The information providing processing illustrated in FIG. 11 is implemented by the user terminal 110 or the staff terminal 40 and the data processing server 60. The user terminal 110 displays the scan screen GA6 (see FIG. 10) on the display 117 on the basis of the startup operation of the log browsing application APb by the end user EU (S111). Such a scan screen GA6 can also be displayed on the display 47 of the staff terminal 40 by the tap operation on the selection icon SI4 (see FIG. 5) displayed on the top screen GA1. Therefore, the processing of the user terminal 110 described below can also be implemented by the staff terminal 40.

The user terminal 110 reads the item code Cd attached to the cargo IMd delivered to the end user EU on the scan screen GA6 to acquire the item ID (S112). The user terminal 110 transmits the acquired item ID to the front server 70 together with a providing request of history information (traceability information) associated with the item ID (S113). The front server 70 receives the providing request of the information associated with the cargo IMd by the request acceptance unit 75 (S114).

The request acceptance unit 75 requests the blockchain server 90 managing the site information keeping chain BC1 to provide the site passage information, the cargo receipt information, and the delivery information associated with the item ID via the cargo information processing unit 71 and the site information processing unit 81 (S115).

In the blockchain server 90, in response to a request from the front server 70, the site information providing unit 93 extracts the site passage information associated with the item ID, the cargo receipt information, and the delivery information by searching the site information keeping chain BC1 (S116). The site information providing unit 93 provides the extracted site passage information or the like to the data providing unit 76 of the front server 70 (S117). As a result, the data providing unit 76 acquires the specific site passage information in which the passage of the cargo IMd to be referred to through the site TB is recorded from a large number of pieces of site passage information managed by the site information keeping chain BC1.

The request acceptance unit 75 requests the blockchain server 90 managing the temperature information keeping chain BC2 to provide the sensor coordination information and the temperature measurement information associated with the item ID via each of the temperature information processing units 72 and 84 (S118).

In the blockchain server 90, in response to a request from the front server 70, the temperature information providing unit 96 extracts the sensor coordination information associated with the item ID by searching the temperature information keeping chain BC2. Furthermore, the temperature information providing unit 96 extracts the temperature measurement information associated with the item ID from the temperature measurement information managed by the temperature information keeping chain BC2 by searching using the cooler box ID of the sensor coordination information as a key (S119). The temperature information providing unit 96 provides the extracted temperature measurement information or the like to the data providing unit 76 of the front server 70 (S120). As a result, the data providing unit 76 acquires the temperature measurement information associated with the cargo IMd.

The request acceptance unit 75 grasps at least one cooler box ID used to acquire the position measurement information based on the sensor coordination information acquired from the temperature information providing unit 96. The sensor coordination information records a history of association and disassociation between the item ID and one or the plurality of cooler box IDs. The request acceptance unit 75 requests the blockchain server 90 managing the position information keeping chain BC3 to provide the position measurement information associated with the cooler box ID via each of the position information processing units 73 and 87 (S121).

In the blockchain server 90, the position information providing unit 99 extracts the position measurement information in response to a request from the front server 70. Specifically, the position information providing unit 99 extracts the position measurement information associated with the cooler box ID by searching from the position measurement information managed by the position information keeping chain BC3 using the cooler box ID as a key (S122). The position information providing unit 99 provides the extracted position measurement information to the data providing unit 76 of the front server 70 (S123). As a result, the data providing unit 76 acquires the position measurement information associated with the cargo IMd.

The data providing unit 76 combines the site passage information, the temperature measurement information, and the position measurement information provided from each blockchain server 90 to generate providing data to be provided to the user terminal 110 (S124). As an example, the data providing unit 76 generates list data, movement trajectory data, temperature transition data, and the like in which each piece of information is summarized on a time axis for the cargo IMd in a time range from a start time of the cargo receipt information to an end time of the delivery information. The data providing unit 76 can combine the site passage information, the temperature measurement information, and the position measurement information having different acquisition cycles according to each measurement cycle by arranging them on the time axis. The data providing unit 76 provides the generated providing data to the user terminal 110 by transmission (S125).

When acquiring the providing data by the data processing unit 123, the user terminal 110 causes the display control unit 124 to display a log display screen on the display 117 (S126). The user terminal 110 causes the log browsing application APb to display a list display screen GA7, a route display screen GA8, a temperature chart display screen GA9, and the like illustrated in FIG. 10 on the display 117 as the log display screen.

The list display screen GA7 is a log display screen generated on the basis of the list data. On the list display screen GA7, at least a site name of the site TB in which the site passage information is registered and the passage time of the site TB are displayed. On the list display screen GA7, a part of temperature information and the position information measured during the movement between the sites may be incorporated in the list and displayed.

The route display screen GA8 is a log display screen generated on the basis of the movement trajectory data. On the route display screen GA8, a transport route TR of the cargo IMd with a cargo receiving place and a delivery place as a start point and an end point, respectively, is displayed on a map. The transport route TR is generated by complementing the space between the site position data recorded in the site passage information with the in-transport position data during the transportation period of time recorded in the position measurement information. The route display screen GA8 implements information presentation that satisfies the user's need to know what transport route TR the cargo IMd has followed to arrive. In the route display screen GA8, for example, the display color of the transport route TR may be changed on the basis of the temperature measurement information during transport.

The temperature chart display screen GA9 is a log display screen generated on the basis of the temperature transition data. The temperature chart display screen GA9 displays a line graph with a horizontal axis as a time axis and a vertical axis as a temperature axis. On the temperature chart display screen GA9, the cooler box ID used for accommodating the cargo IMd may be displayed in a list together with the line graph of the temperature change.

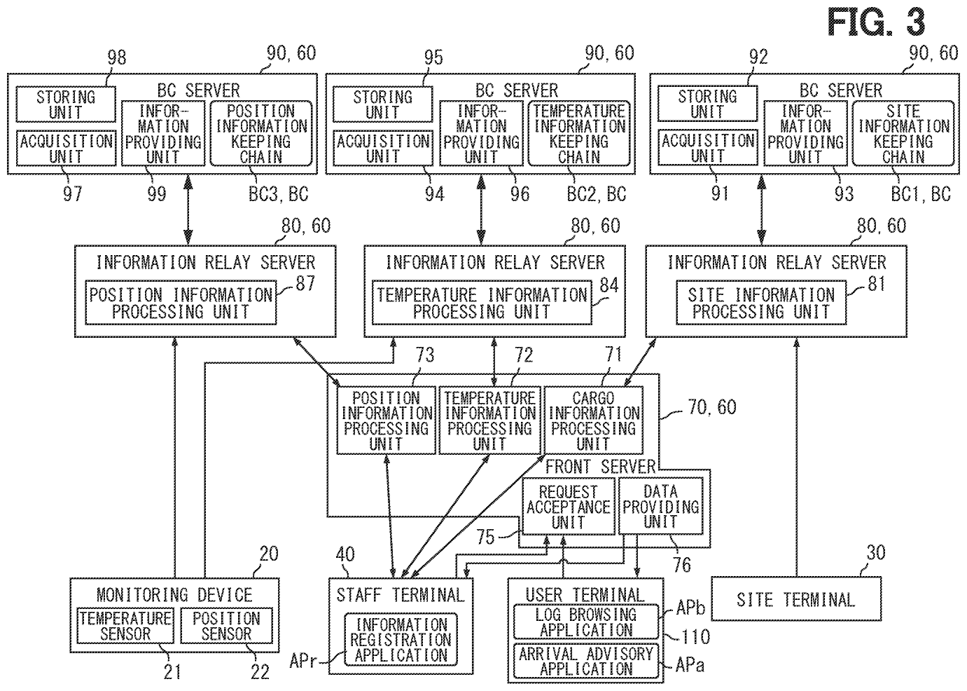

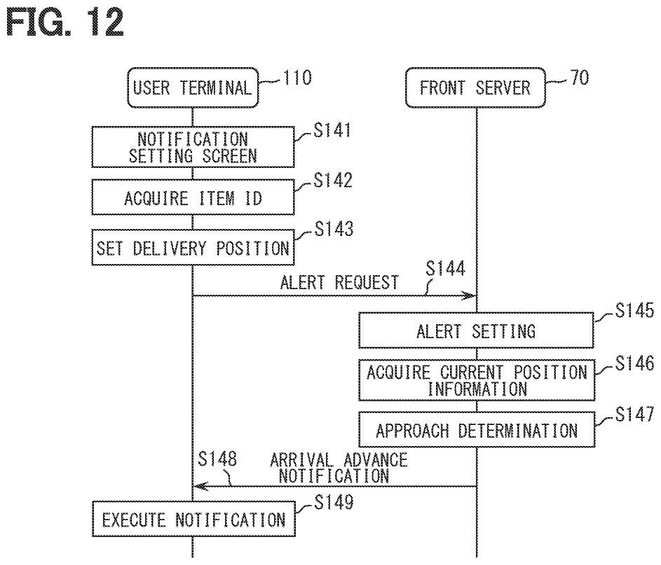

Next, details of an advance notice processing of giving an advance notice of the arrival of the cargo IMd being transported to the user terminal 110 will be described below on the basis of FIG. 12 and with reference to FIGS. 3 and 4. The advance notice processing is implemented by the user terminal 110 and the data processing server 60.

The user terminal 110 displays a notification setting screen on the display 117 on the basis of the startup operation of the arrival advisory application APa by the end user EU (S141). On the notification setting screen, the item ID is input by the end user EU. The item ID is previously notified to the end user EU by a contact means such as an email from the logistics-related company LC, for example. The user terminal 110 acquires the item ID input by the end user EU (S142).

The user terminal 110 sets a delivery position on the notification setting screen (S143). As an example, the position data acquired by the GNSS receiver 118 is input to the delivery position. The position data of the delivery destination address registered in the cargo IMd may be automatically input to the delivery position. In such processing, the delivery position setting in the user terminal 110 is omitted. The user terminal 110 transmits the item ID and delivery location information to the data processing server 60 (front server 70) together with an alert request (S144).

The front server 70 acquires the alert request transmitted from the user terminal 110, the position data of the end user EU (consignee) serving as the requesting source, and the like as the delivery position information. Then, the front server 70 sets an alert for the cargo IMd to which the item ID is attached on the basis of the alert request (S145).

The front server 70 acquires the latest position measurement information (current position information) associated with the cargo IMd from the position information providing unit 99 (S146). The front server 70 determines whether the cargo IMd has approached the end user EU who is an alert requesting source on the basis of comparison between the current position information measured by the position sensor 22 associated with the cargo IMd and the delivery position information (S147). When the cargo IMd is not approaching the end user EU, the front server 70 updates the current position information at a predetermined cycle and repeats the approach determination. Then, for example, when the cargo IMd moves to a position of about 1 km to the end user EU, the front server 70 determines that the cargo IMd has approached, and transmits an arrival advisory to the user terminal 110 that is the requesting source (S148). The user terminal 110 executes notification to the end user EU on the basis of the arrival advisory received from the front server 70 (S149).

In the first embodiment described above, the item information associated with the cargo IMd is stored in association with the blockchain BC. Therefore, it is possible to reduce the falsification risk of the information associated with the cargo IMd.

In addition, in the first embodiment, the site passage information, the temperature measurement information, and the position measurement information acquired as the item information have different data input or data measurement cycles. Then, the plurality of pieces of item information having different periods for input or measurement are individually stored in association with the plurality of different blockchains BC. Therefore, since a recording cycle of each item information is different, even if a large difference occurs in the amount of accumulated information, the processing of searching for the information associated with the cargo IMd from the information accumulated in each blockchain BC is less likely to be delayed. By enhancing the searchability of the accumulated information in this manner, it is possible to secure the convenience of the accumulated information while reducing the falsification risk.

In the first embodiment, the temperature measurement information repeatedly measured by the temperature sensor 21 associated with the cargo IMd is stored in association with the temperature information keeping chain BC2. On the other hand, the position measurement information repeatedly measured by the position sensor 22 associated with the cargo IMd is stored in association with the position information keeping chain BC3. As described above, if the temperature measurement information and the position measurement information having different measurement cycles are managed using different blockchains BC, the processing of searching for the temperature measurement information and the position measurement information associated with the cargo IMd is unlikely to be delayed. Therefore, the detailed history information associated with the cargo IMd can be managed while securing convenience.

Furthermore, in the first embodiment, the site passage information related to the passage of the cargo IMd through the site TB is stored in association with the blockchain BC. As described above, the item information associated with the cargo IMd is not limited to the sensor information, and the distribution information input in the distribution process is also included in the item information stored in the blockchain BC, so that a series of information indicating the overall view of the distribution process can be stored in a state with a low falsification risk.

In addition, in the first embodiment, the site passage information is stored in association with the site information keeping chain BC1 different from the temperature information keeping chain BC2 and the position information keeping chain BC3. The input cycle of the site passage information is inevitably longer than that of the temperature measurement information and the position measurement information. Therefore, by separating the site information keeping chain BC1 that manages the site passage information from the blockchain BC that manages the sensor information, a search processing of each item information can be implemented more smoothly. Therefore, convenience can be secured even if not only the sensor information but also the distribution information such as the site passage information is stored in a state where the falsification risk is low.

Furthermore, in the first embodiment, the measurement cycle of the position measurement information is changed on the basis of the transport information related to the transport of the cargo IMd. According to the adjustment of the measurement cycle based on such transport information, the reproduction accuracy of the transport route TR of the cargo IMd is easily secured. As a result, the convenience of the history information associated with the cargo IMd is improved.

More specifically, in the case of displaying the transport route TR (see FIG. 10) in distribution, when a long and complicated movement trajectory is to be drawn, it is necessary to measure and accumulate position data frequently. As a result, in the blockchain server 90, the file size of the position measurement information increases. In addition, since the moving speed during transport is different, when the position data is measured at a constant cycle, there is a possibility that the position data becomes too dense or the position data becomes too sparse.

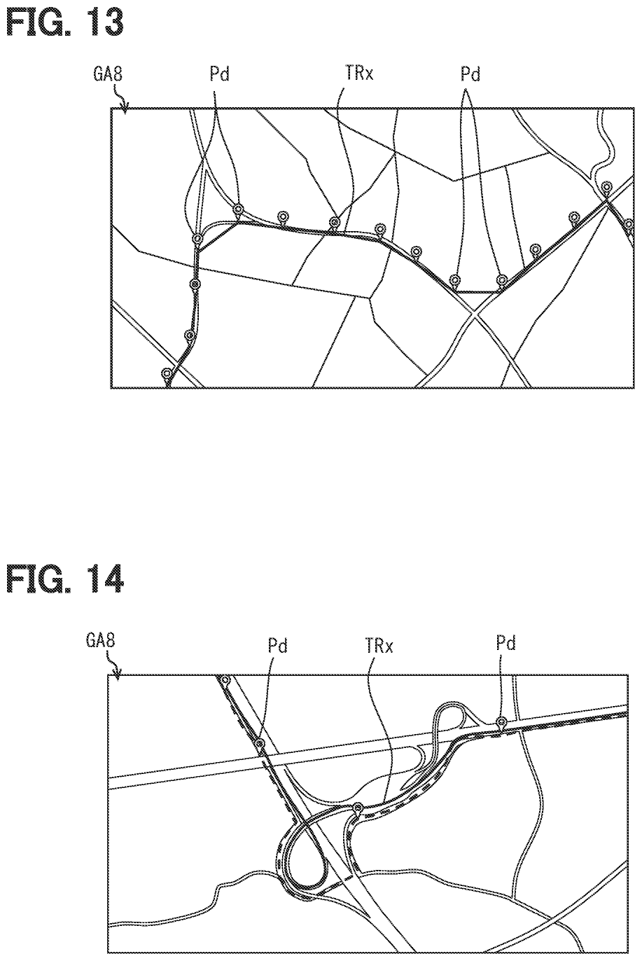

As an example, in the route display screen GA8 of Comparative Example 1 illustrated in FIG. 13, a transport route TRx is drawn by linearly connecting measurement points Pd indicated by the individual position data. Therefore, when the position data becomes sparse, the displayed transport route TRx has a shape deviated from the road on the map.

As another example, in the route display screen GA8 of Comparative Example 2 illustrated in FIG. 14, the same function as the route search of the general navigation device is used, and the movement trajectory is reproduced from the measurement points Pd of less position data. However, in the transport route TRx to which the route search function is applied, for example, in a case of moving on a general road along an expressway (see a broken line in FIG. 14), an erroneous transport route TRx as if being on an expressway is generated.

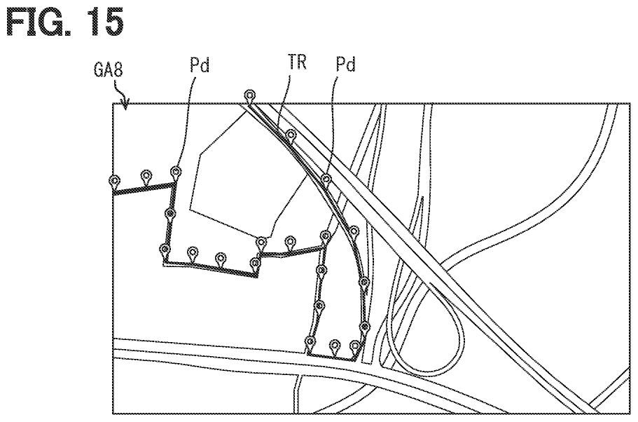

In contrast, in the first embodiment, the measurement cycle of the position measurement information is shortened as the cargo IMd transport speed increases based on the transport information. Specifically, in accordance with the speed of the transport truck TV, the measurement frequency is reduced at low speed, and the measurement frequency is increased at high speed. According to the above adjustment, the acquisition cycle of the position measurement information, in other words, the interval of the measurement points Pd on the map as illustrated in FIG. 15 can be appropriate. As a result, the transport route TR displayed on the route display screen GA8 is hardly deviated from the road, and it is possible to correctly indicate whether the transport route TR is an expressway or a general road.

As an example, in the first embodiment, the controller 23 adjusts the measurement cycle of the position information so that the measurement points Pd are displayed at intervals of about 50 m. As a result, on the route display screen GA8, display of the transport route TR without any sense of incongruity is realized.

In addition, in the first embodiment, the measurement cycle of the position measurement information is changed depending on the type of transport facility for transporting the cargo IMd. For example, in a case where the cargo IMd is transported by the transport facility that linearly moves such as the aircraft and the ship, the measurement frequency is reduced. As a result, the transport route TR by the aircraft, the ship, and the like is displayed without any sense of incongruity while suppressing the data amount of the accumulated position measurement information. On the other hand, in a case where the cargo IMd is transported by the transport facility such as the transport truck TV and the carrier TC, the measurement frequency is increased. As a result, it is possible to display the transport route TR along the road on the map without any sense of incongruity (see FIG. 15).

Furthermore, in the first embodiment, the measurement cycle of the temperature measurement information is adjusted on the basis of the form information related to the form of the cargo IMd. Therefore, in a case where the cargo IMd whose temperature is likely to change is transported, it is possible to strictly implement low temperature management by increasing the measurement frequency. On the other hand, when the cargo IMd whose temperature hardly changes is transported, the measurement frequency can be reduced to reduce an amount of accumulated data of the temperature measurement information.

In addition, in the first embodiment, as the surface area relative to the volume of the cargo IMd becomes smaller, the measurement cycle of the position measurement information is made longer. As the surface area with respect to the volume decreases, the temperature of the cargo IMd is less likely to change. On the other hand, as the surface area relative to the volume increases, the temperature of the cargo IMd easily changes. Therefore, by using the volume and surface area of the cargo IMd as indices, a balance between ensuring reliability of low-temperature management and suppressing the amount of accumulated data can be appropriate. Note that the volume and surface area of the cargo IMd may be estimated by image analysis or the like by capturing the cargo IMd with the camera 46 of the staff terminal 40.

Furthermore, in the first embodiment, information provided to a requesting source of a providing request is managed using the blockchain BC. Therefore, it is possible to reduce the falsification risk of the information associated with the cargo IMd.

Specifically, in the first embodiment, specific temperature measurement information associated with the cargo IMd is acquired from information managed by the temperature information keeping chain BC2, and specific position measurement information associated with the cargo IMd is acquired from information managed by another position information keeping chain BC3. Then, the providing data to be provided to the requesting source is generated by combining the temperature measurement information and the position measurement information. As described above, if the measurement information stored by the separate information keeping chains BC2 and BC3 is individually acquired, the searchability of each piece of measurement information is easily secured even if the plurality of types of measurement information is associated with one cargo IMd. Therefore, the processing of providing the history information managed using the blockchain BC can be efficiently implemented.

Furthermore, in the first embodiment, the providing data is generated by processing of combining the temperature measurement information and the position measurement information having different measurement cycles according to the respective measurement cycles. As described above, with the time axis as a reference, the data providing unit 76 can group the pieces of measurement information stored in different blockchains BC and having different measurement cycles as organized providing data. As a result, information providing that is easy for the end user EU to understand is realized.

In addition, in the first embodiment, the position measurement information includes the in-transport position data recorded in the transport facility moving between the sites TB. Therefore, it is possible to notify the end user EU of not only the rough information recorded in each site TB but also the transport route TR on which the cargo IMd has actually moved by the route display screen GA8 or the like. As a result, information providing that is highly convenient for the end user EU is realized.

In addition, in the first embodiment, the position measurement information is combined with the site passage information, and the movement trajectory data in which the space between the site position data of each site TB recorded in the site passage information is complemented by the in-transport position data during the transportation period of time is generated as the providing data. As a result, the transport route TR on which the cargo IMd has actually moved can be displayed on the route display screen GA8 with higher accuracy.

In addition, if the history information of the cargo IMd being moved can be browsed on the user terminal 110 or the staff terminal 40, the end user EU or the staff member can grasp the current position of the latest cargo IMd in real time. As a result, the convenience of the history information is further improved.

Furthermore, in the first embodiment, an arrival advance notification is implemented in a case where the cargo IMd approaches the end user EU on the basis of comparison between the current position information measured by the position sensor 22 and the delivery position information designated by the end user EU. According to such an arrival advance notification, the position measurement information of the cargo IMd transmitted to the data processing server 60 at a high frequency is effectively used. As a result, the convenience of the end user EU as the consignee is more easily ensured.

In the first embodiment, the temperature measurement information corresponds to “item information”, “first information”, and “specific first information”, and the position measurement information corresponds to “second measurement information”, “second information”, and “specific second information”. In addition, the site passage information corresponds to “item information”, “site information”, and “specific site information”. Furthermore, the site information keeping chain BC1 corresponds to a “third blockchain”, the temperature information keeping chain BC2 corresponds to a “first blockchain”, and the position information keeping chain BC3 corresponds to a “second blockchain”. Then, the cargo IMd corresponds to the “distribution item”, the site TB corresponds to a “relay site”, and the data processing server 60 corresponds to a “computer”.

### Second Embodiment

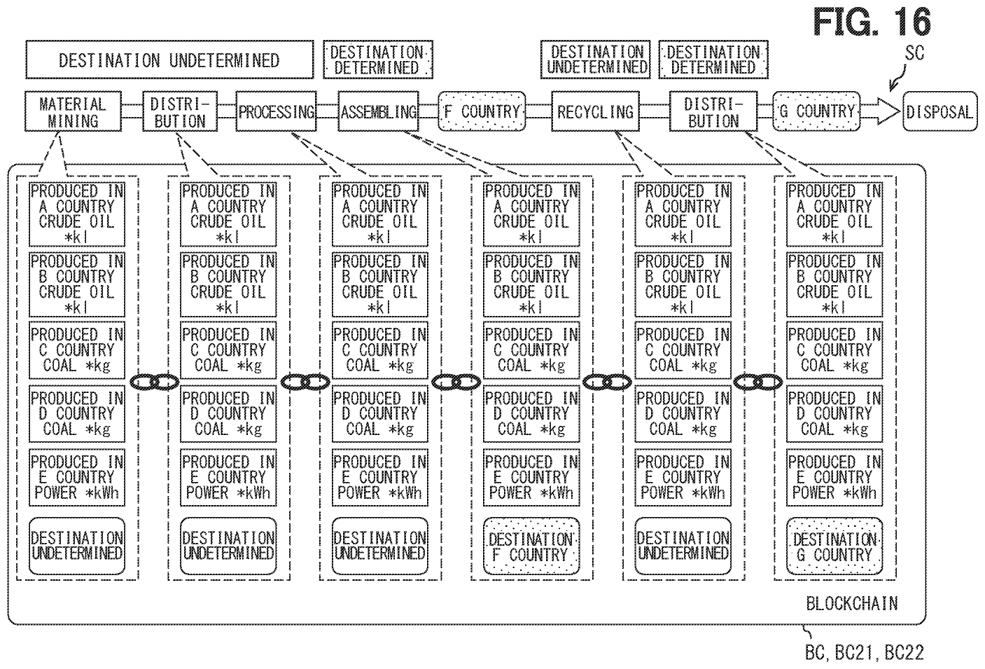

In a second embodiment of the present disclosure illustrated in FIGS. 16 to 18, the supply chain management system is applied to management of a supply chain SC. The supply chain SC is constructed including a plurality of vendors, and is, for example, a connection between vendors for delivering industrial products, agricultural products, marine products, and the like to the end user EU. In addition to suppliers SP such as a material miner, a material producer, a processor, and a testing company, the vendors may include an assembly manufacturer MF, a distributor LG, a recycler, a seller, and the like. In the supply chain SC, a product having undergone a step in one supplier SP (for example, a miner) is delivered to the next supplier SP (for example, a processor) through the distributor LG. The assembly manufacturer MF is supplied with products manufactured by a large number of suppliers SP through the distributor LG.

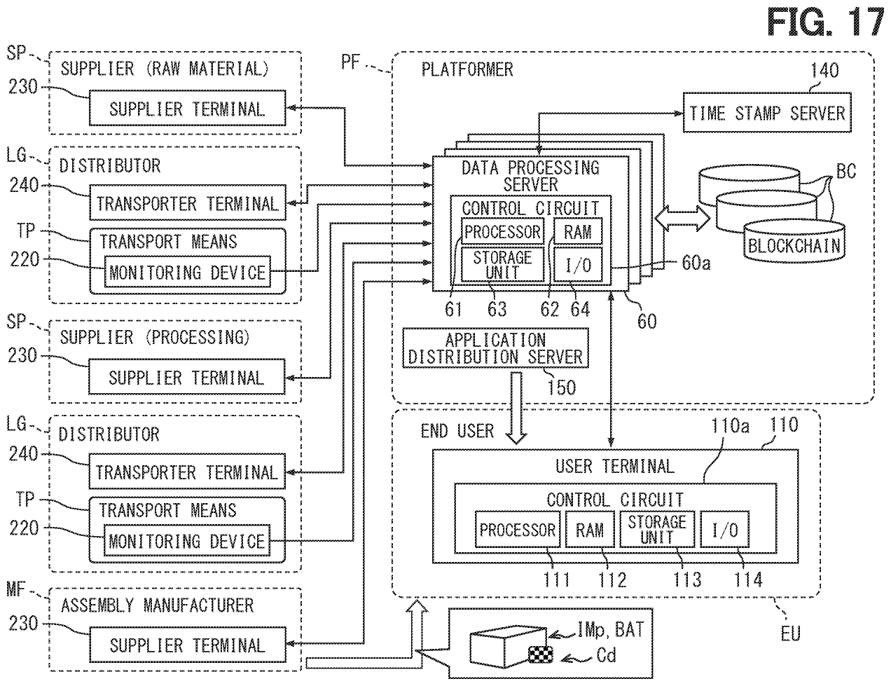

The supply chain management system (see FIG. 17) manages a transaction record or the like of an item transacted between each vendor in the supply chain SC. The transaction record is history information that realizes traceability of an item traded between vendors, and includes a large number of pieces of information indicating a time, a place, and the like when the transaction occurs. In a case where the item is an industrial product, for example, information regarding raw materials, information regarding processing and assembly, distribution routes, and the like are included in the transaction record. If the item is a foodstuff, information indicating a best-before expiration or a use-by expiration may be further included in the transaction record.

The supply chain management system collects and accumulates information related to an emission amount (hereinafter, carbon release amount) of a greenhouse gas emitted by manufacturing and distribution of an item as one item information generated in each process of manufacturing and distribution of the item. Information related to the carbon release amount is stored in association with the transaction record. Similar to the transaction record, the supply chain management system uses the technology of the blockchain BC to store information related to the carbon release amount so as not to be falsified.

The supply chain management system can calculate the carbon release amount of an item using the accumulated information and present the carbon release amount as a carbon footprint to the end user EU or the like. The supply chain management system can present not only the carbon footprint of a final product IMp to be provided to the end user EU, but also the carbon release amount for each vendor and the cumulative carbon release amount up to a specific vendor (see FIGS. 22 to 25). Furthermore, the supply chain management system may be capable of collecting and accumulating the information of the carbon release amount by utilization of the final product IMp of the end user EU and presenting a cumulative carbon footprint including the utilization.

The production of the item may include steps such as mining and recycling of raw materials of the item. In addition, the carbon release amount in a step related to disposal such as incineration and landfill of an item may be managed by the supply chain management system. In addition, the greenhouse gas whose emission amount is recorded may be only carbon dioxide, and may appropriately include a greenhouse gas other than carbon dioxide, specifically, methane, nitrous oxide, hydrofluorocarbons, perfluorocarbons, sulfur hexafluoride, and the like. In this case, the emission amount of greenhouse gas other than carbon dioxide is converted into the emission amount of carbon dioxide and is calculated into the presented value of the carbon footprint.

The supply chain management system is applied, by way of example, to the management of information related to rechargeable batteries (hereinafter, the battery BAT) for electric vehicles or for industry, and enables the presentation of transaction records and carbon footprints related to the battery BAT. The battery BAT may be a battery module in which a plurality of battery cells are combined, or may be a battery unit (or a battery pack) in which the plurality of battery modules are combined. As each battery cell, a nickel-metal hydride battery, a lithium ion battery, a sodium battery, and the like can be employed. In addition, the battery BAT as a recording target of the carbon footprint may be limited to a battery module exceeding a predetermined capacity (for example, 2 kWh), or may have a configuration of a predetermined capacity or less.

The battery BAT is used, for example, as a primary use (see FIG. 16, F Country), in an electric vehicle, a plug-in hybrid vehicle, a fuel cell vehicle, and the like. Furthermore, the battery BAT is used as a secondary battery (see FIG. 16, G Country) to store a back-up power source or renewable energy at the time of disaster. The supply chain management system enables management of history information, a carbon release amount, and the like over the entire life cycle of the battery BAT assumed to be used as described above.

The supply chain management system is constructed by a supplier terminal 230, a transporter terminal 240, a monitoring device 220, the data processing server 60, and the like. Each element constituting the supply chain management system is connected to a network as one node.

The supplier terminal 230 is operated by the supplier SP or the assembly manufacturer MF included in a manufacturing step of the final product IMp (the battery BAT or the like). The supplier terminal 230 is installed, for example, at a manufacturing site of the supplier SP and the assembly manufacturer MF. An intermediate product shipped from the manufacturing site of the supplier SP in the preceding step is delivered to the manufacturing site. The delivered intermediate product is subjected to processing or the like at the manufacturing site, and is shipped as a new intermediate product to the manufacturing site of the supplier SP or the assembly manufacturer MF in the subsequent step.

The item code Cd in which the item ID is recorded is attached to items such as the intermediate product and the final product IMp shipped from each supplier SP. As an example, the item code Cd obtained by printing a two-dimensional code including the item ID on a paper medium is attached to a main body, a package, and the like of each item. The item ID is unique data for identifying individual items. The item ID may be a sequence of numbers or the like generated on the basis of a rule defined in advance, or may be a hash value or the like generated from data indicating a distribution history. The item ID may be changed (updated) every time a step in each supplier SP is performed, or may be continuously used by the plurality of suppliers SP. In the supply chain management system, the item ID is provided from the data processing server 60 to the supplier terminal 230, and the item information is managed in a format associated with the item ID.

Similar to the site terminal 30 (see FIG. 1) of the first embodiment, the supplier terminal 230 is connected to a scanner, a camera, and the like capable of reading the item code Cd, and includes a display and a control circuit. The scanner, the camera, and the like may be integrated with the supplier terminal 230 as a configuration of the supplier terminal 230. The supplier terminal 230 registers a usage amount of at least one of power and an energy resource used in relation to manufacturing of an item in the supply chain management system in the manufacturing site.

The usage amount information indicating the usage amount of the power and the energy resource is information for calculating the carbon release amount. The usage amount information (hereinafter, power usage amount information) indicating the usage amount of power is associated with production place information indicating a country or an area where the power is produced (generated) (see FIG. 16). In the production place information, a range different from a country, an area, and the like may be designated. For example, in a specific country, an area having a high power generation ratio of renewable energy (state, prefecture, special district, etc.) may be registered as the production place. In addition, for example, type information indicating power generation methods such as hydraulic power, thermal power, wind power, geothermal power, nuclear power, and solar power, information indicating whether power generation is performed by renewable energy, and the like may be further associated with the power usage amount information.

Type information indicating a type of energy and production place information indicating a country or an area where an energy resource is produced (mined) are associated with usage amount information (hereinafter, fuel usage amount information) indicating a usage amount of the energy resource (see FIG. 16). The energy resource is, for example, fuels such as crude oil, coal, natural gas, or hydrogen. The fuel usage amount information is stored in the data processing server 60 for each type of energy resource (fuel) and for each production place.

The supplier terminal 230 may be capable of calculating the carbon release amount used for manufacturing an item in addition to the power usage amount information and the fuel usage amount information, and registering the calculated carbon release amount in the supply chain management system. The carbon release amount (production cost) for each item is calculated by dividing the total amount of the greenhouse gas emitted from the manufacturing site by the number of items manufactured in the manufacturing site (see the following Formula 1).

$$Production Cost = {\sum }_{i} \frac{{C}_{f}^{i}}{{N}_{f}^{i}} \qquad [ Formula 1 ]$$

In the above Formula 1, i represents an identification symbol of a manufacturing site, Cf represents an emission amount per second of the manufacturing site, and Nf represents the number of items manufactured per second of the manufacturing site.

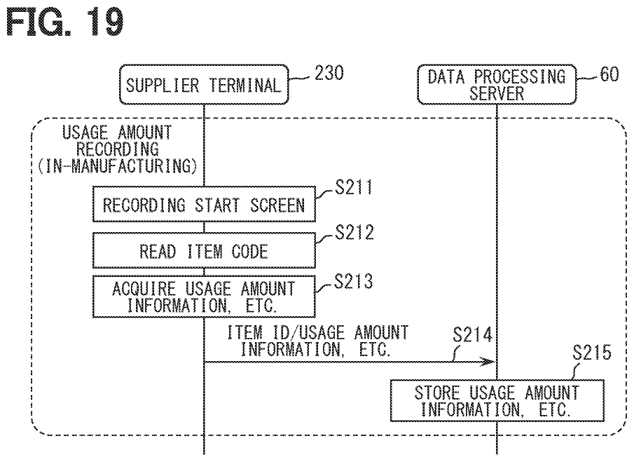

The supplier terminal 230 implements manufacturing usage amount storage processing (see FIG. 19) as a processing for transmitting the power usage amount information and the fuel usage amount information related to the manufacturing of the item to the data processing server 60. The supplier terminal 230 displays a recording start screen on the display on the basis of the staff member's operation for information registration (S211). In a state where the recording start screen is displayed, the item code Cd attached to the item to be shipped is read by the scanner or the like (S212).

The supplier terminal 230 acquires the usage amount information used for manufacturing for the item from which the item code Cd has been read (S213). The supplier terminal 230 further acquires the production place information and the type information in addition to the usage amount information. The supplier terminal 230 may acquire the usage amount information or the like automatically calculated on the basis of the collection information of the sensor group installed in the manufacturing site, or may acquire a value input by the staff member in the manufacturing site. The supplier terminal 230 transmits the item ID recorded in the item code Cd, the usage amount information, the production place information, the type information, and the like to the data processing server 60 (S214).

The data processing server 60 acquires the item ID, the usage amount information, and the like received from the supplier terminal 230 by reception (S214). The data processing server 60 stores the usage amount information or the like in association with the blockchain BC in a state of being able to be associated with the item ID (S215). The usage amount information may be further associated with acquisition time (reception time) or the like of the usage amount information.

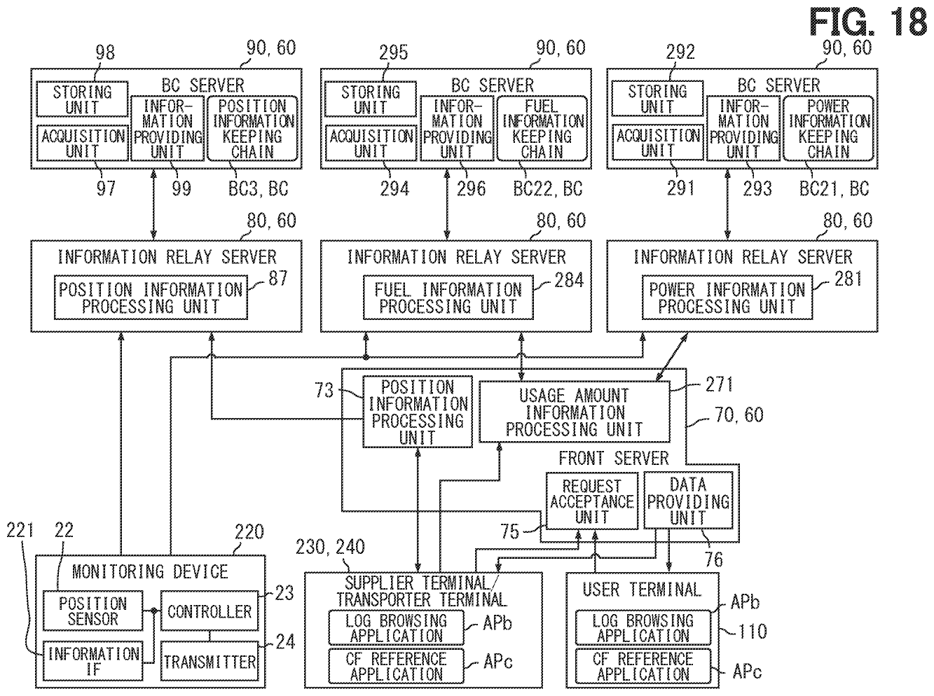

The data processing server 60 stores the usage amount information of power and fuel by associating the production place information for each type of power and fuel. Specifically, the usage amount information is accumulated in the blockchain BC in the form of “crude oil produced in A country_kl”, “crude oil produced in B country_kl”, “coal produced in C country_kg”, “coal produced in D country_kg”, and “power produced in E country_kWh” (see FIG. 16). The usage amount information for each type may be collectively accumulated in one blockchain BC, or may be accumulated in the plurality of blockchains BC for each type and production place. In the second embodiment, a power information keeping chain BC21 for accumulating the power usage amount information and a fuel information keeping chain BC22 for accumulating the fuel usage amount information are individually provided (see FIG. 18).

The transporter terminal 240 and the monitoring device 220 are operated by the distributor LG responsible for a distribution step of items such as the intermediate products or final products. The transporter terminal 240 may be a fixed terminal installed in each site TB (see FIG. 2) of the distributor LG, or may be a mobile terminal carried by the staff member who operates a transport means TP such as the transport truck TV and the carrier TC (see FIG. 2). The transporter terminal 240 has functions corresponding to the site terminal 30 and the staff terminal 40 (see FIG. 1) of the first embodiment. The transporter terminal 240 includes a camera, a scanner, and the like for reading the item code Cd or the like, a display, a control circuit, and the like.

The monitoring device 220 is provided on a transport pallet, a transport box, and the like that transports the item. The monitoring device 220 is mounted on the transport means TP together with the transport pallet, the transport box, and the like containing a large number of items, and is transported together with the items or the like. Each of the transport pallet and the transport box is provided with a distribution code in which a transport ID is recorded. The transport ID is unique data identifying the transport pallet and the transport box. The distribution code is, for example, the two-dimensional code such as the QR code, and is attached to the outer surface of the transport pallet, the transport box, and the like in a state of being printed on a paper medium or the like.

The monitoring device 220 repeatedly acquires the measurement information associated with the item and uploads the acquired measurement information to the data processing server 60 as item information. The monitoring device 220 includes an information interface 221 (see FIG. 18) in addition to the position sensor 22, the controller 23, and the data transmitter 24 which are substantially the same as those of the monitoring device 20 (see FIG. 1) of the first embodiment. The information interface 221 is communicably connected to a communication network or a control device mounted on the transport means TP by wire, radio, and the like. The information interface 221 periodically acquires the usage amount of power or fuel consumed by the transport means TP.

Here, the usage amount information acquired by the information interface 221 is changed according to the type of a power source mounted on the transport means TP. When a battery for traveling is mounted on the transport means TP and the transport means TP travels by consuming power stored in the battery, the information interface 221 grasps power usage amount information indicating the usage amount of power used for traveling. Furthermore, when an internal combustion engine or a fuel cell is mounted on the transport means TP and the transport means TP consumes the fuel and travels, the information interface 221 grasps the type information indicating the type of the consumed fuel and the usage amount information indicating the usage amount of the fuel. The fuel is, for example, an energy resource such as gasoline, light oil, hydrogen, liquefied petroleum gas, or compressed natural gas. The information interface 221 may be capable of acquiring production place information indicating a production place of the consumed fuel together with the usage amount information or the like. Furthermore, in a case where the transport means TP can use both power and fuel for traveling, the information interface 221 acquires each usage amount information of power and fuel, or the like.

Similar to the first embodiment, the monitoring device 220 sequentially changes the measurement cycle of the usage amount information and the position information under the control of the controller 23 based on the speed information, the type information, and the like of the transport means TP. The monitoring device 220 sequentially or at regular time intervals transmits accompanying usage amount information such as type information and current position information to the data processing server 60 in association with a sensor ID for identifying the monitoring device 220. Also in the second embodiment, one of the sensor ID and the transport ID may also serve as the other. That is, the sensor ID and the transport ID may be the same identification information. The monitoring device 220 registers the usage amount of at least one of the power and the fuel used in relation to the distribution of the item in the transport means TP in the supply chain management system.

The monitoring device 220 or the data processing server 60 may be able to calculate the carbon release amount used for distribution of the item in addition to the power usage amount information and the fuel usage amount information, and register the calculated carbon release amount in the supply chain management system. The carbon release amount (delivery cost) for each item is calculated from the total amount of greenhouse gases emitted from the transport means TP, the weight of the item, the transport distance, and the like (see the following Formula 2).

$$Delivery Cost = {\sum }_{j} {C}_{t}^{j} \times w \times {d}^{j} \qquad [ Formula 2 ]$$

In the above Formula 2, j represents an identification symbol of the transport means, Ct represents an emission amount of the transport means per weight and distance, w represents a weight per item, and d represents a transport distance moved by the transport means. As the transport distance, a distance of an actual transport route specified from position data during transport continuously measured by the position sensor 22 is adopted.

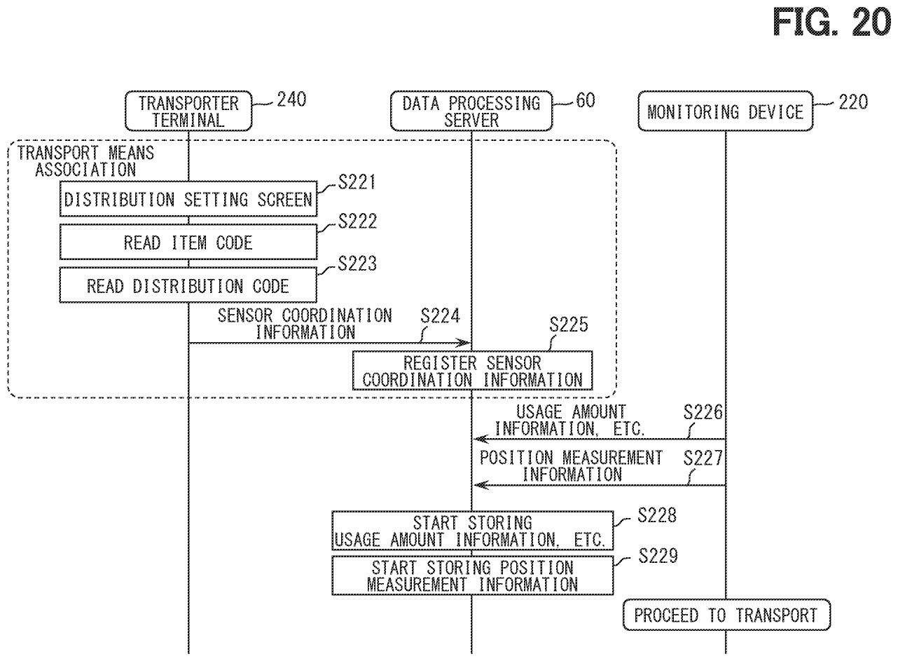

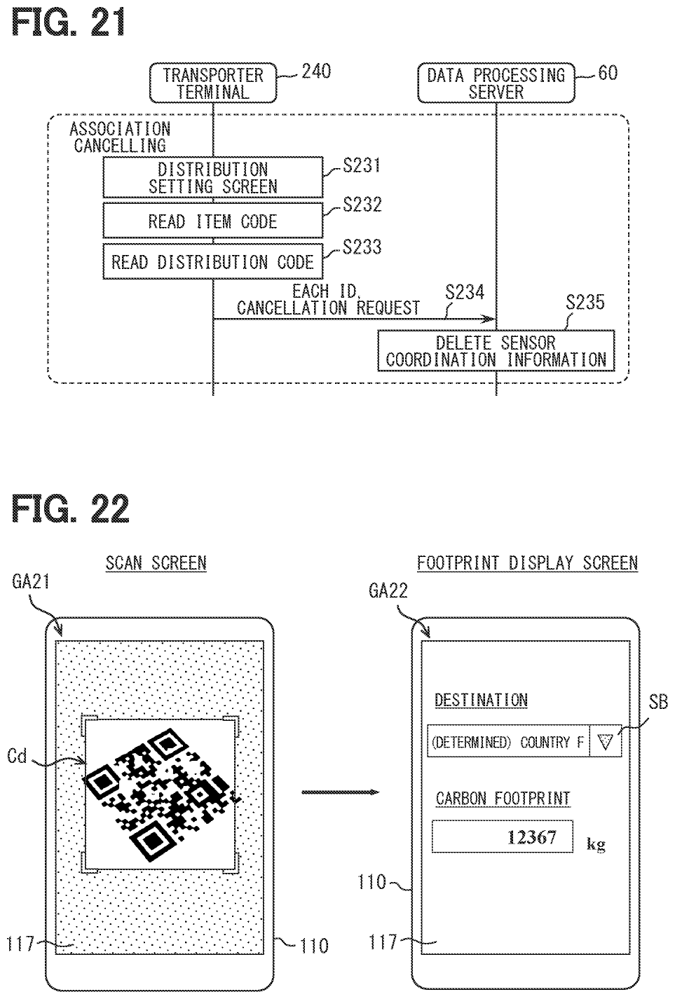

The transporter terminal 240 implements a sensor registration processing (see FIG. 20) and a registration cancellation processing (see FIG. 21) as processing for storing the power usage amount information and the fuel usage amount information related to the distribution of the item in the data processing server 60. The sensor registration processing is processing of notifying the data processing server 60 of the item ID and the sensor ID (or the transport ID) at the time of shipment from the manufacturing site, in other words, at the time of receipt of a cargo from the distributor LG in order to associate the transport means TP (monitoring device 220) with the item. The registration cancellation processing is processing of requesting the data processing server 60 to cancel the association between the monitoring device 220 and the item at the time of delivery from the distributor LG, in other words, at the time of delivery to the manufacturing site.

In the sensor registration processing, the transporter terminal 240 displays a distribution setting screen on the display on the basis of the staff member's operation in order to register each ID (S221). In a state where the distribution setting screen is displayed, the item code Cd attached to the item to be shipped is read by the camera or the like (S222). Furthermore, the distribution code attached to the transport pallet, the transport box, and the like is read (S223). The reading order of each code may be appropriately changed. The transporter terminal 240 transm its the item ID extracted from the item code Cd and the transport ID (the same information as the sensor ID) extracted from the distribution code to the data processing server 60 as the sensor coordination information (S224).

The data processing server 60 acquires the sensor coordination information received from the transporter terminal 240 by reception (S224). The data processing server 60 registers the acquired sensor coordination information (S225). As described above, the monitoring device 220 is associated with the item being transported. The data processing server 60 acquires the usage amount information and the position measurement information by reception from the monitoring device 220 transported by the transport means TP together with the item (S226 and S227). The data processing server 60 starts storing the usage amount information and the position measurement information associated with the item ID (S228 and S229). As described above, the usage amount information and the position measurement information are stored in a state associated with the power information keeping chain BC21, the fuel information keeping chain BC22, and the position information keeping chain BC3 (see FIG. 18).

Also in the registration cancellation processing, the transporter terminal 240 displays the distribution setting screen on the display (S231). In a state where the distribution setting screen is displayed, the item code Cd attached to the item to be delivered is read by the camera or the like (S232). Furthermore, the distribution code attached to the transport pallet, the transport box, and the like is read (S233). The reading order of each code may be appropriately changed. The transporter terminal 240 transmits the item ID and the transport ID (sensor ID) to the data processing server 60 together with a cancellation request (S234). The data processing server 60 deletes the sensor coordination information on the basis of the cancellation request received from the transporter terminal 240 (S235), and cancels the association between the item and the monitoring device 220. In the supplier SP or the like to which the item is delivered from the distributor LG, a delivery processing of reading the item code Cd of the delivered item is implemented using the supplier terminal 230.

The data processing server 60 is a server device managed by the platformer PF of the supply chain management system together with the time stamp server 140 and the application distribution server 150. Similar to the first embodiment, the data processing server 60 is a computer mainly including the control circuit 60a including the processor 61, the RAM 62, the storage unit 63, the input/output interface 64, the bus connecting these, and the like (see FIG. 17). The data processing server 60 can communicate with a large number of supplier terminals 230, a large number of transporter terminals 240, and a large number of monitoring devices 220 through the network. In the supply chain management system, the front server 70, the plurality of (three) information relay servers 80, and the plurality of (three) blockchain servers 90 are provided as the data processing servers 60 (see FIG. 18).

The front server 70 includes, as functional units based on an information management program and an information providing program, the position information processing unit 73, the request acceptance unit 75, and the data providing unit 76 that are substantially the same as those in the first embodiment, and a usage amount information processing unit 271. The usage amount information processing unit 271 receives, from the supplier terminal 230, the power usage amount information, the fuel usage amount information, and the like used in relation to manufacturing of the item. The usage amount information processing unit 271 receives the sensor coordination information, the cancellation request, and the like from the transporter terminal 240. The usage amount information processing unit 271 transmits the usage amount information, the sensor coordination information, and the like acquired by reception to the information relay server 80.

The information relay server 80 receives the usage amount information, the position measurement information, and the like from the monitoring device 220 and the front server 70, and transmits the usage information, the position measurement information, and the like to the blockchain server 90. In the information relay server 80 that receives the power usage amount information, a power information processing unit 281 is constructed as a functional unit based on the information management program and the information providing program. Similarly, in the information relay server 80 that receives the fuel usage amount information, a fuel information processing unit 284 is constructed as a functional unit based on the information management program and the information providing program. Similarly, the power information processing unit 281 transmits reception information to the blockchain server 90 that accumulates the power usage amount information. The fuel information processing unit 284 transmits the reception information to the blockchain server 90 that accumulates the fuel usage amount information.

The blockchain server 90 acquires the usage amount information, the position measurement information, and the like relayed by the information relay server 80, and manages the acquired information by the blockchain BC. In the blockchain server 90 that manages the power usage amount information, a power information acquisition unit 291, a power information storing unit 292, and a power information providing unit 293 are constructed as functional units based on the information management program and the information providing program. Similarly, a fuel information acquisition unit 294, a fuel information storing unit 295, and a fuel information providing unit 296 are constructed in the blockchain server 90 that manages the fuel usage amount information.

Each information acquisition unit 291, 294 acquires the item ID, the usage amount information, and the like from the information processing unit 281, 284. Each information storing unit 292, 295 stores the usage amount information or the like acquired by each information acquisition unit 291, 294 in association with the power information keeping chain BC21 or the fuel information keeping chain BC22. Each information providing unit 293, 296 extracts the usage amount information associated with the item ID from the information stored in each of the information keeping chains BC21 and BC22. Each information providing unit 293, 296 relays the extracted usage amount information to the information processing unit 281, 284 and transmits the extracted usage amount information to the usage amount information processing unit 271.

Next, a method of confirming the carbon footprint of the item using the carbon footprint reference application (hereinafter, a CF reference application APc) or the log browsing application APb will be described. The CF reference application APc and the log browsing application APb are distributed to the user terminal 110, the supplier terminal 230, the transporter terminal 240, and the like by the application distribution server 150.

The CF reference application APc (see FIG. 18) is an application program for referring to the carbon footprint of the item. The CF reference application APc installed on the user terminal 110 of the end user EU is mainly used to confirm the carbon footprint of the final product IMp.

The user terminal 110 displays a scan screen GA21 (see FIG. 22) on the display 117 on the basis of the startup operation of the CF reference application APc by the end user EU. The end user EU captures the item code Cd attached to the final product IMp in a state where the scan screen GA21 is displayed on the user terminal 110. When the image of the item code Cd is successfully captured on the scan screen GA21, the user terminal 110 displays a footprint display screen GA22 (see FIG. 22) on the display 117. A destination set for the final product IMp and the carbon footprint of the final product IMp are displayed on the footprint display screen GA22. An article name or the like of the final product IMp may be further displayed on the footprint display screen GA22.

Here, the method of calculating the carbon footprint is not uniquely determined, and is changed according to a plurality of conditions. Specifically, the method of calculating the carbon footprint varies depending on the country or area in which the final product IMp is used, in other words, the destination of the final product IMp. In addition, even when the same energy resource (fuel) is used for manufacturing or distribution, the method of calculating the carbon footprint varies depending on the production place where the energy resource is produced. Furthermore, even in the case of the final product IMp whose destination has been determined, when the final product IMp is transferred to another destination (see FIG. 16, G country) by, for example, recycling (secondary use) or the like, the method of calculating the carbon footprint needs to be changed.

In consideration of the above background, the CF reference application APc can be operated by the user to change the destination. The end user EU can change the destination by the tap operation on a selection button SB displayed next to the destination. The user terminal 110 displays the carbon footprint calculated by the calculation method corresponding to the selected destination on the footprint display screen GA22.

When installed in the supplier terminal 230 or the transporter terminal 240, the CF reference application APc can display the carbon footprint calculated by the calculation method corresponding to the provisionally set destination. This is a function considering that the destination of the final product IMp is often undetermined at the stage of the intermediate product. Similar to the CF reference application APc installed in the supplier terminal 230 or the transporter terminal 240, the CF reference application APc installed in the user terminal 110 may be capable of displaying the carbon footprint corresponding to the provisionally set destination.

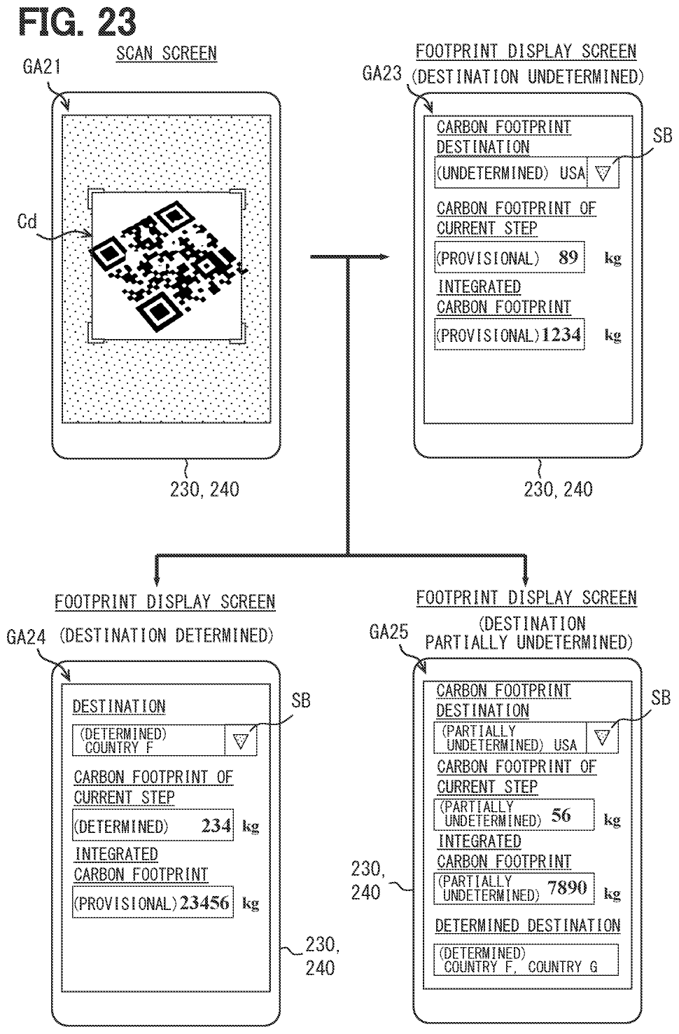

The supplier terminal 230 or the transporter terminal 240 (hereinafter, a terminal 230, 240) displays the scan screen GA21 (see FIG. 23) on the display similar to the user terminal 110 on the basis of the startup operation of the CF reference application APc. When the item code Cd attached to the intermediate product or the final product IMp is read by the terminal 230, 240, any one of footprint display screens GA23 to GA25 (see FIG. 23) is displayed on the display.

The footprint display screen GA23 is a screen displayed when the destination of the item is not determined. For example, in a case where the carbon footprint is referred to by the supplier SP that performs material mining or processing, the distributor LG that transports the intermediate product, and the like (see FIG. 16), the footprint display screen GA23 is displayed. On the footprint display screen GA23, a destination provisionally set for calculating the carbon footprint, the carbon footprint in the current process, and the carbon footprint obtained by integrating the emission amount up to the current step are displayed. Each carbon footprint is a value calculated by a calculation method corresponding to a provisionally set destination. The value of each carbon footprint is accompanied by a display indicating that it is a provisionally calculated numerical value.

The footprint display screen GA24 is a screen displayed when the destination is determined. For example, when the carbon footprint is referred to by the assembly manufacturer MF (see FIG. 16) that assembles the final product IMp, the footprint display screen GA24 is displayed. The determined destination, the carbon footprint in the current step, and the carbon footprint obtained by integrating the emission amount up to the current step are displayed on the footprint display screen GA24. The value of each carbon footprint is accompanied by a display indicating a determined numerical value.

The footprint display screen GA25 is a screen displayed when destinations of some items among items managed by the same item ID are determined and destinations of remaining items are not determined. For example, when raw materials, parts, and the like of the same lot are exported to a plurality of countries as intermediate products, the destination is partially undetermined. On the footprint display screen GA25, in addition to the destination provisionally set for the undetermined item, the carbon footprint in the current step, and the carbon footprint obtained by integrating the emission amount up to the current step, the destination that has already been determined is displayed. In the footprint display screen GA25, a display indicating that some destinations are undetermined is added to the provisionally set destinations and the values of the carbon footprints.

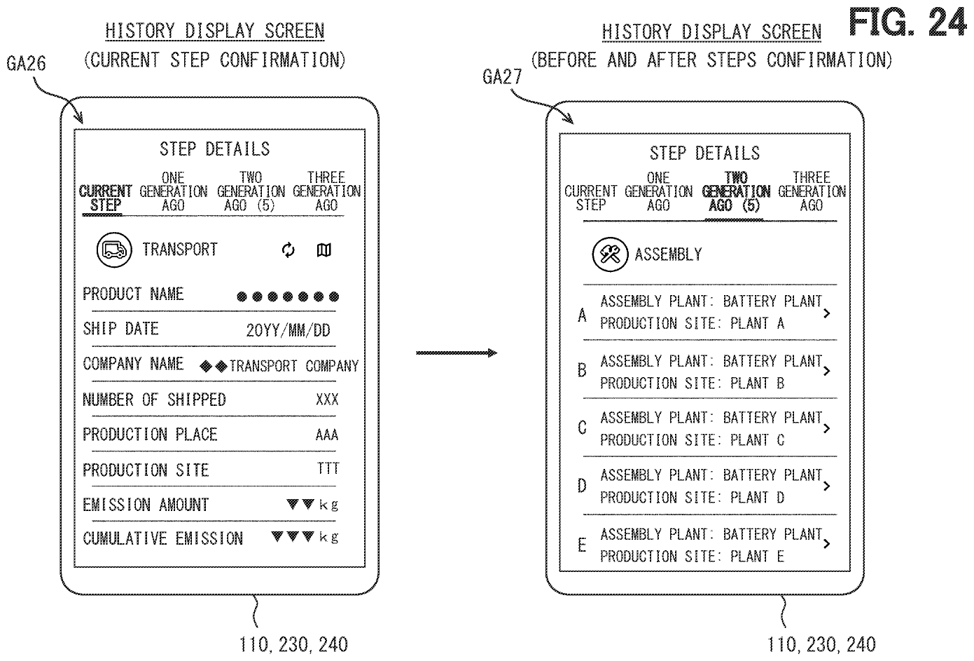

The log browsing application APb is an application program for referring to a transaction record accumulated in the supply chain management system. The log browsing application APb has a function similar to that of the CF reference application APc, and can present the carbon footprint together with the transaction record. The user terminal 110, the supplier terminal 230, and the transporter terminal 240 (hereinafter, the terminal 110, 230, 240) on which the log browsing application APb is installed display the scan screen GA21 (see FIGS. 22 and 23) on the display on the basis of the startup operation by the user. When the item code Cd attached to the item is read by the terminal 110, 230, 240, a history display screen GA26 (see FIG. 24) is displayed on the display.

Details of the current (last) step are displayed on the history display screen GA26 to be displayed first. The history display screen GA26 displays, as a transaction record, a product name, a ship date or a manufacturing date, a company name, the number of items (number of shipped), a production place, a site name where a manufacturing step is implemented, and the like. In addition, the history display screen GA26 displays the carbon footprint in the process being displayed and the cumulative carbon footprint obtained by integrating the emission amounts up to the step being displayed. Furthermore, the determined or provisionally set destination of the item may be displayed on the history display screen GA26 or the transition screen from the history display screen GA26 together with a selection button SB (see FIG. 22) for changing the destination.

When a swipe operation or the like for tracing back the steps is input to the terminal 110, 230, 240 in a state where the history display screen GA26 is displayed, the display transitions to a history display screen GA27 (see FIG. 24) of the preceding step. For example, in a case where a plurality of items is delivered to the assembly manufacturer MF in an assembly step, the history display screen GA27 displays a list of the plurality of items delivered to the assembly manufacturer MF. When an arbitrary item is selected, the terminal 110, 230, 240 causes display of the display to transition to a screen displaying a transaction record and a carbon footprint associated with the selected item.

Furthermore, the log browsing application APb may be capable of displaying the route display screen GA8 (see FIG. 15) displaying the transport route TR in the specific distribution step. In addition, in a case where the final product IMp is the battery BAT, the log browsing application APb may be capable of displaying information indicating a deterioration degree of the battery BAT such as SOH (State of Health).

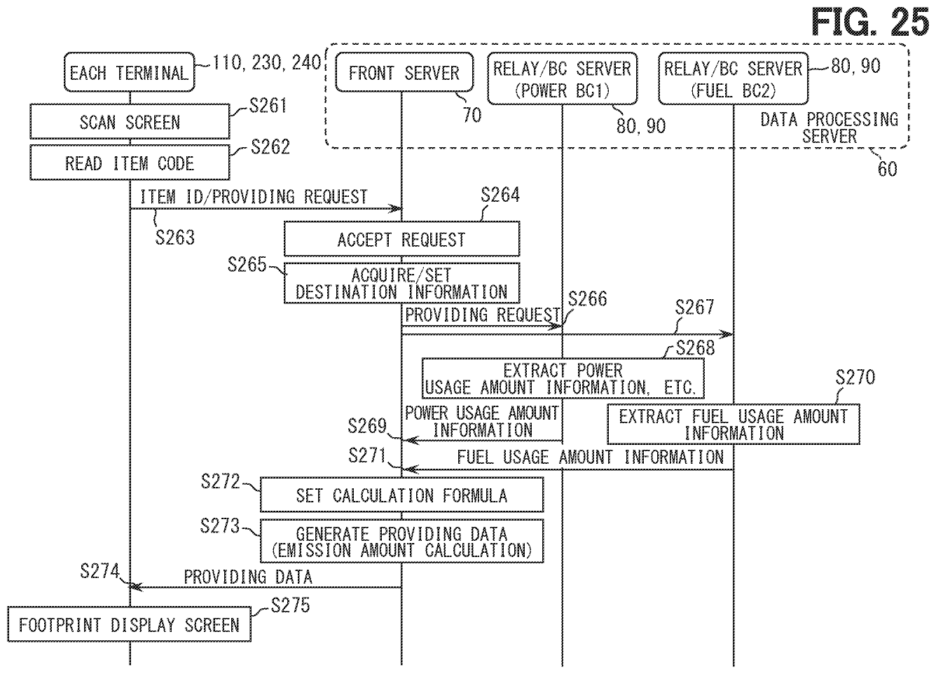

Next, details of the information providing processing for causing the terminal 110, 230, 240 to display the carbon footprint will be described below on the basis of FIG. 25 and with reference to FIGS. 16 to 18 and FIGS. 22 to 24.

The terminal 110, 230, 240 displays the scan screen GA21 on the display on the basis of the startup operation of the applications APb and APc by the end user EU, the staff member, and the like (S261). The terminal 110, 230, 240 reads the item code Cd attached to the item on the scan screen GA21 and acquires the item ID (S262). The terminal 110, 230, 240 transmits the acquired item ID to the front server 70 together with the providing request of the carbon footprint associated with the item ID (S263).

The front server 70 receives the item ID, the providing request, and the like (S263), and the request acceptance unit 75 accepts the providing request of the carbon footprint (S264). The front server 70 acquires a destination associated with the item based on the item ID (S265). The information on the destination is notified to the front server 70 by, for example, the supplier terminal 230 of the assembly manufacturer MF. The front server 70 stores information on the destination in association with the blockchain BC. The information of the destination may be updatable in a format in which the information of the destination at the time of the primary use is not deleted in consideration of the secondary use of the item. In a case where the information of the destination has an updated history, the latest information of the destination is used in the information providing processing.

The front server 70 determines whether information on a destination associated with the item is registered. When the information of the destination associated with the item is registered and the destinations of all the items are determined, the front server 70 sets the registered destination. On the other hand, when the information on the destination associated with the item is not registered, or when the destinations of some items are undetermined, the front server 70 provisionally sets a specific destination. For example, a country that has been often set as a destination in the past, a country that tends to have a larger carbon footprint value, and the like is set as a temporary destination. Furthermore, an inquiry about a provisionally set destination may be made to the terminal 110, 230, 240. In this case, an arbitrary destination selected by the end user EU, the staff member, and the like is provisionally set.

The front server 70 requests, via the power information processing unit 281 and the fuel information processing unit 284, the usage amount information, the production place information, and the type information associated with the item ID to each of the blockchain servers 90 that manage said information (S266 and S267).

Each blockchain server 90 extracts the usage amount information associated with the item ID in response to a request from the front server 70. Specifically, using the item ID as a key, the power information providing unit 293 extracts, by searching, the power usage amount information, the production place information, and the like associated with the item ID from the power usage amount information managed by the power information keeping chain BC21 (S268). The power information providing unit 293 provides the extracted power usage amount information or the like to the data providing unit 76 of the front server 70 (S269).

Similarly, the fuel information providing unit 296 extracts, by searching, the fuel usage amount information, the production place information, the type information, and the like associated with the item ID from the fuel usage amount information managed by the fuel information keeping chain BC22 using the item ID as a key (S270). The fuel information providing unit 296 provides the extracted fuel usage amount information or the like to the data providing unit 76 of the front server 70 (S271).

In each of the blockchains BC21 and BC22, the usage amount information obtained by integrating the usage amounts for a plurality of steps of the supply chain SC may be prepared in advance. For example, in a case where the manufacturing of the item is advanced to the assembly step (see FIG. 16), each information providing unit 293, 296 prepares integrated usage amount information obtained by summing usage amount information in a material mining step, the distribution step, and a processing step for each type and production place. Specifically, the integrated usage amount information for each type and production place is prepared in advance with the contents of “crude oil produced in A country, total_kl” . . . , “coal produced in C country, total_kg” . . . , and “power produced in E country, total_kWh”. According to such preparation in advance, the processing of searching the supply chain SC for the usage amount information is omitted. As a result, the processing of extracting the usage amount information associated with the item can be speeded up.

The data providing unit 76 of the front server 70 acquires the power usage amount information and the fuel usage amount information used in relation to the manufacturing and distribution of the item that is the target of the providing request (S269 and S271). As described above, the data providing unit 76 acquires the usage amount information which is raw data for calculating the carbon release amount and is managed by the blockchain BC for each type of power and fuel. Production place information indicating a production place of power is associated with the power usage amount information, and production place information indicating a production place of fuel (energy resource) is associated with the fuel usage amount information.

The data providing unit 76 refers to the information of the destination set for the item and prepares a calculation method corresponding to the destination (S272). As described above, the calculation method corresponding to the destination is a calculation method defined by a law, regulation, rule, and the like for each country or area as the destination. Specifically, the data providing unit 76 sets a formula or table reflecting a calculation method corresponding to the destination. Such a formula or table has contents capable of reflecting fuel production place information.

The data providing unit 76 calculates the carbon release amount of the item by arithmetic processing of integrating the emission amount individually calculated from the usage amount information for each type and production place, for example, as shown in the following Formula 3 (S273).

Carbon Footprint=f_{FoA,G}(C_{FoA})+f_{FcC,G}(C_{FcC})+f_{EE,G}(C_{EE}) [Formula 3]

In the above Formula 3, C_{FoA} represents the total value of the usage amount of a specific fuel (for example, crude oil) produced in A country, C_{FcC} represents the total value of the usage amount of the specific fuel (for example, coal) produced in C country, and C_{EE} represents the total value of the usage amount of the power produced in E country. Furthermore, f_{FoA,F} is a formula for calculating the carbon release amount from the usage amount of the specific fuel produced in A country in the destination F country, and f_{FcC,F} is a formula for calculating the carbon release amount from the usage amount of the specific fuel produced in C country in the destination F country. In addition, f_{EE,F} is a formula for calculating the carbon release amount from the usage amount of power produced in E country in the destination F country.

The unit of the total value of the usage amounts may be different from each other, for example, kl, kg, kWh, and the like. In addition, the formulae of f_{FoA,F}, f_{FcC,F}, f_{EE,F} and the like are changed depending on the destination, and are defined in advance so that the carbon release amount (the unit is kg) can be calculated from the total value of the usage amounts in different units. In addition, at least a part of the above formula may be replaced with a table that outputs the carbon release amount from the total value of the usage amount.

The data providing unit 76 calculates the carbon release amount corresponding to the destination of the item and reflecting the production place information by the calculation method using the above Formula 3 or the like. The data providing unit 76 transmits the calculated value of the carbon release amount as providing data to the terminal 110, 230, 240 of the requesting source (S274).

Note that, in a case where there is a providing request of the carbon footprint in an initial step of the supply chain SC, the carbon release amount calculated in advance using the above Formulae 1 and 2 may be provided to each terminal as providing data. By returning such a calculated value, it is possible to quickly display a value with a relatively small error on each terminal.

When receiving the providing data transmitted from the front server 70, the terminal 110, 230, 240 displays one of the footprint display screens GA22 to GA25 and the history display screen GA26 according to the content of the providing data (S274). That is, the terminal 110, 230, 240 presents the acquired carbon release amount as a carbon footprint to the end user EU, the staff member, and the like.

Furthermore, the supplier terminal 230 or the transporter terminal 240 may be capable of printing the carbon footprint on a paper medium such as a label instead of or together with the screen display of the carbon footprint. The label is attached to the item and distributed with the item. The label is further printed with a predetermined logo mark to indicate that the stated value is the carbon footprint. The logo mark is changed according to the destination of the item. The label describing the carbon footprint may be integrated with a label indicating the item code Cd.

Also in the second embodiment described above, the usage amount information associated with items such as the intermediate product and the final product IMp is stored in association with the blockchain BC. Therefore, the same effects as those of the first embodiment can be obtained, and the falsification risk of information can be reduced.

In addition, in the second embodiment, the position measurement information and the usage amount information having different measurement cycles are individually stored in association with the plurality of different blockchains BC3, BC21, and BC22. Therefore, similar to the first embodiment, it is easy to secure the convenience of the accumulated information while reducing the falsification risk.

Furthermore, in the second embodiment, the usage amount information for each type of power and fuel is stored in association with the blockchain BC. Specifically, the power usage amount information, the fuel usage amount information for crude oil, and the fuel usage amount information for coal are individually stored. As described above, as long as raw data for calculating the carbon footprint is stored, even if the method for calculating the carbon footprint is different for each destination, the carbon footprint corresponding to the determined destination can be calculated at the stage when the destination is determined.

In addition, in the second embodiment, the production place information indicating the fuel production place is associated with the fuel usage amount information. As a result, even for the same type of fuel, it is possible to sum up the fuel usage amount by distinguishing for each production place. According to the above, even when a different calculation method is applied to each fuel production place, an accurate carbon footprint value can be calculated.

In the second embodiment, the usage amount information managed by the blockchain BC is acquired for each type of power and fuel, and the calculation method corresponding to the destination set for the item is prepared. Then, the carbon release amount of the item is calculated from the usage amount information for each type using the prepared calculation method. As described above, as long as raw data for calculating the carbon footprint can be acquired, even if the method for calculating the carbon footprint is different for each destination, the carbon footprint corresponding to the determined destination can be calculated at the timing when the destination is determined.

Furthermore, in the second embodiment, the usage amount information associated with the production place information of the used fuel is acquired, and the carbon release amount reflecting the production place information is calculated. According to the above, even when a different calculation method is applied to each fuel production place, an accurate carbon footprint value can be calculated.

In addition, in the second embodiment, when the destination is not set for the item, the carbon release amount is calculated using the provisionally set calculation method. Thus, for example, in the first half of the supply chain SC or the like, even when the destination is not set, it is possible to grasp a provisional carbon release amount.

In the second embodiment, the supply chain management system can strictly manage the carbon footprint of the battery BAT. Therefore, it can be ensured that the battery BAT provided by the supply chain SC is a product manufactured in consideration of carbon neutral. According to the above, the supply chain management system can contribute to the improvement of the added value of the battery BAT.

In the second embodiment, the intermediate product and the final product IMp correspond to an “item”, and the fuel corresponds to an “energy resource”.

### Third Embodiment

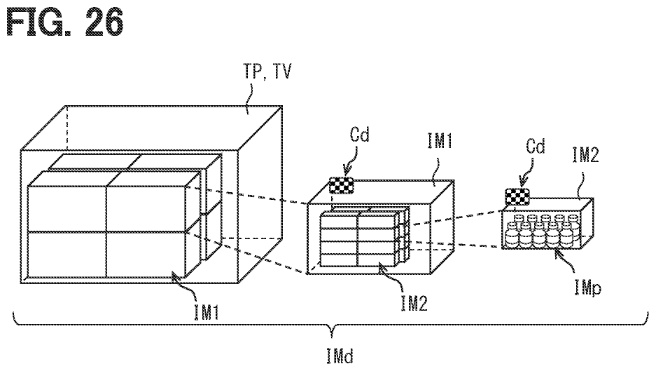

A cold chain management system according to a third embodiment of the present disclosure is a modification of the first embodiment. In the third embodiment, as illustrated in FIGS. 26 and 27, it is assumed that re-packaging occurs for the cargo IMd delivered by the cold chain CC. The re-packaging is an action of changing a packing unit in delivery, and is an action of a vendor responsible for distribution opening a package and distributing the plurality of items contained in the package as a new cargo IMd. The re-packaging can include a work of registering occurrence information of re-packaging in the cold chain management system in addition to a work of changing the packing form of the cargo IMd. The work of registering the occurrence information of the re-packaging may be automated as described later. According to the registration of the occurrence information of the re-packaging, the item information is accumulated in the cold chain management system so as to be associated with the cargo IMd after the packaging form is changed. As an example, in the third embodiment, three categories of a lot IM1, a package IM2, and the final product IMp are set as a packing unit or a distribution unit.

The lot IM1 is a packing unit of the cargo IMd when shipped from a manufacturer DF, and is the largest distribution unit among the three. The package IM2 is a packing unit smaller than the lot IM1. One lot IM1 contains a plurality of (for example, 100) packages IM2. When re-packaging occurs in one lot IM1, distribution of a large number of packages IM2 is started. The final product IMp is a unit that reaches the end user EU and is the smallest of the three distribution units. One package IM2 contains a plurality of (for example, 20) final products IMp. When re-packaging occurs in one package IM2, distribution of a large number of final products IMp is started. The number of categories of the packing unit to be set in the cold chain management system can be appropriately changed according to the characteristics of the cargo IMd delivered by the cold chain CC.

In the cold chain management system, different item IDs are assigned to each of the lot IM1, the package IM2, and the final product IMp. Specifically, a lot ID is assigned to the lot IM1, a package ID is assigned to the package IM2, and a delivery ID is assigned to the final product IMp. The items ID of each category are incorporated in the item code Cd and distributed together with the cargo IMd of each category, similar to the first embodiment. In the item code Cd, an item ID associated before or after re-packaging of the current cargo IMd may be incorporated. The item IDs of each category may be all created at the start of distribution of the lot IM1, or may be generated at the timing of occurrence of re-packaging.

In the cold chain management system, the position measurement information and the temperature measurement information are accumulated in association with different IDs before and after occurrence of re-packaging. Specifically, in a case where the cargo IMd is in the state of the lot IM1 before re-packaging, the item information is stored in the blockchain BC in association with the lot ID of the lot IM1 that is the item before re-packaging. In addition, in a case where the cargo IMd is in the state of the package IM2 after the first re-packaging, the item information is stored in the blockchain BC in association with the package ID of the package IM2 that is the item after re-packaging. Furthermore, in a case where the cargo IMd is in the state of the final product IMp after the second re-packaging, the item information is stored in the blockchain BC in association with the delivery ID of the final product IMp that is the item after re-packaging. As described above, the data amount of the accumulated item information increases in the second half of distribution in which the item ID increases due to occurrence of re-packaging. In other words, in the first half of distribution, the data amount of the accumulated item information can be suppressed by collective management based on the item ID before re-packaging.

The cold chain CC is constructed by vendors such as the manufacturer DF, the distributor LG, a re-packaging vendor WS, and the end user EU. The cold chain CC corresponds to the supply chain SC related to delivery of the cargo IMd. The manufacturer DF is a manufacturer or the like that manufactures the final product IMp. The manufacturer DF packs the final product IMp in units of the package IM2 and the lot IM1 at a manufacturing factory and ships the product to the distributor LG.

The distributor LG distributes the cargo IMd in the unit of the lot IM1. At each centralized warehouse of a manufacturer or a distribution company, the distributor LG implements operations such as loading and unloading of the cargo IMd onto and from the transport means TP (transport truck TV or the like), storing in a cold storage, taking out from the cold storage, loading onto the transport means TP, and delivery to the next step. The plurality of lots IM1 loaded into one transport means TP is delivered to a plurality of (for example, about 10 locations of) different re-packaging vendor WS by a specific distributor LG.

In addition to each operation implemented by the distributor LG, the re-packaging vendor WS implements re-packaging of the cargo IMd. The re-packaging vendor WS changes the packing unit in the distribution process, performs re-packaging by dividing one cargo IMd into a plurality of distribution units, and distributes the cargo IMd to the vendor in the next step. One lot IM1 is divided into the plurality of packages IM2 by being re-packaged before being loaded onto the transport means TP, for example, at a business office of the distribution company. Each package IM2 is delivered from the business office of the distribution company to a plurality of (for example, about five locations) distributors or the like. Then, one package IM2 is divided into the plurality of final products IMp by being re-packaged before being loaded into the transport means TP, for example, at a distributor's warehouse. Each final product IMp is delivered from the distributor's warehouse to the plurality (for example, about five locations) of end users EU.

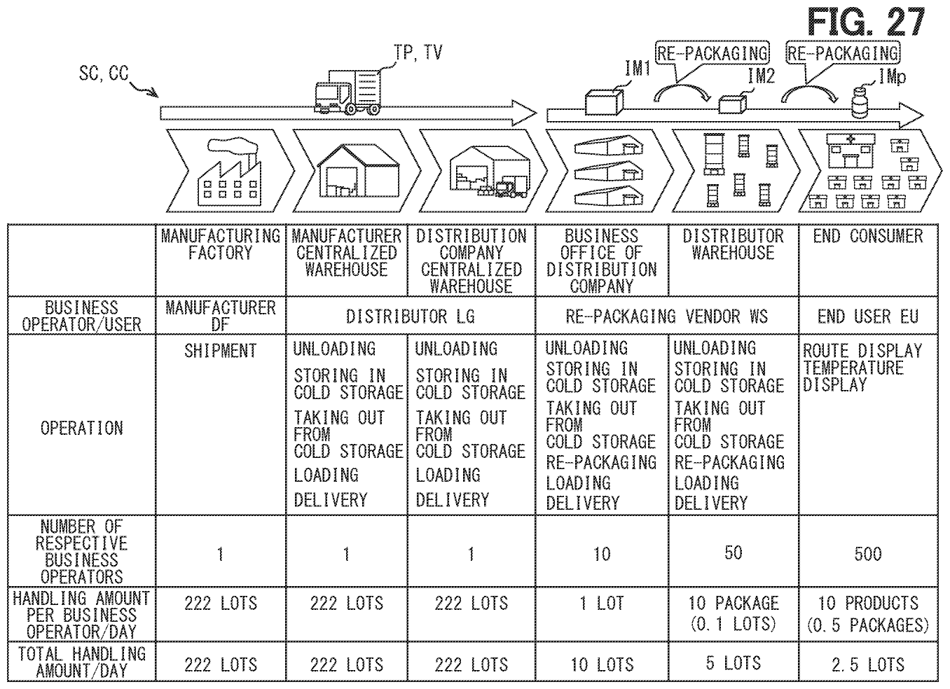

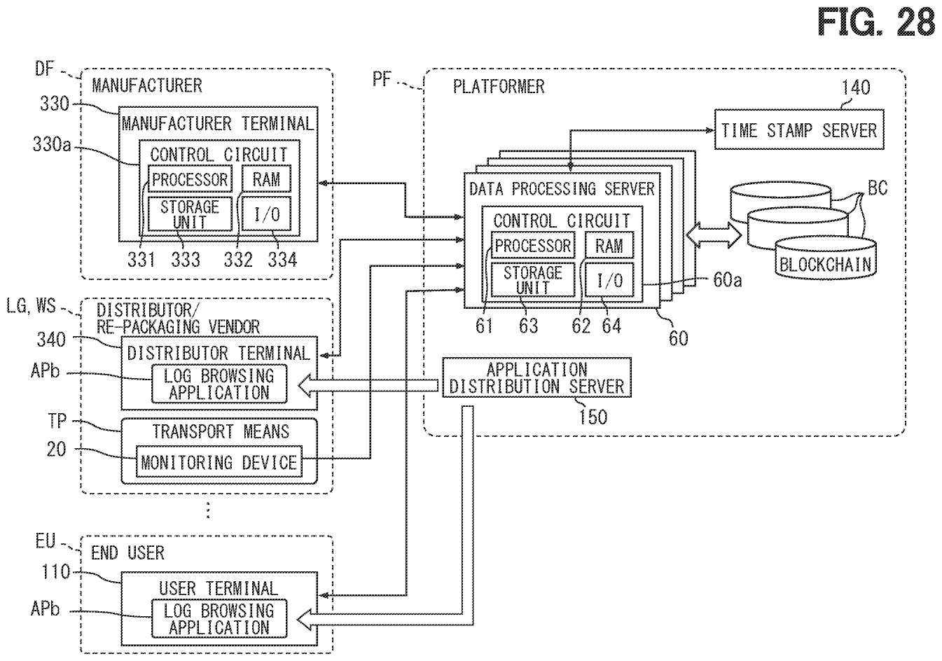

As illustrated in FIG. 28, the cold chain management system is constructed by a manufacturer terminal 330, a distributor terminal 340, the monitoring device 20, the data processing server 60, and the like. Each element constituting the cold chain management system is connected to a network as one node.

The manufacturer terminal 330 is operated by the manufacturer DF that manufactures the final product IMp. The manufacturer terminal 330 may be, for example, a fixed terminal installed in the manufacturing factory (see FIG. 27) or the like of the manufacturer DF, or may be a mobile terminal such as the user terminal 110. The manufacturer terminal 330 is a computer mainly including a control circuit 330a including a processor 331, a RAM 332, a storage unit 333, an input/output interface 334, a bus for connecting them, and the like.

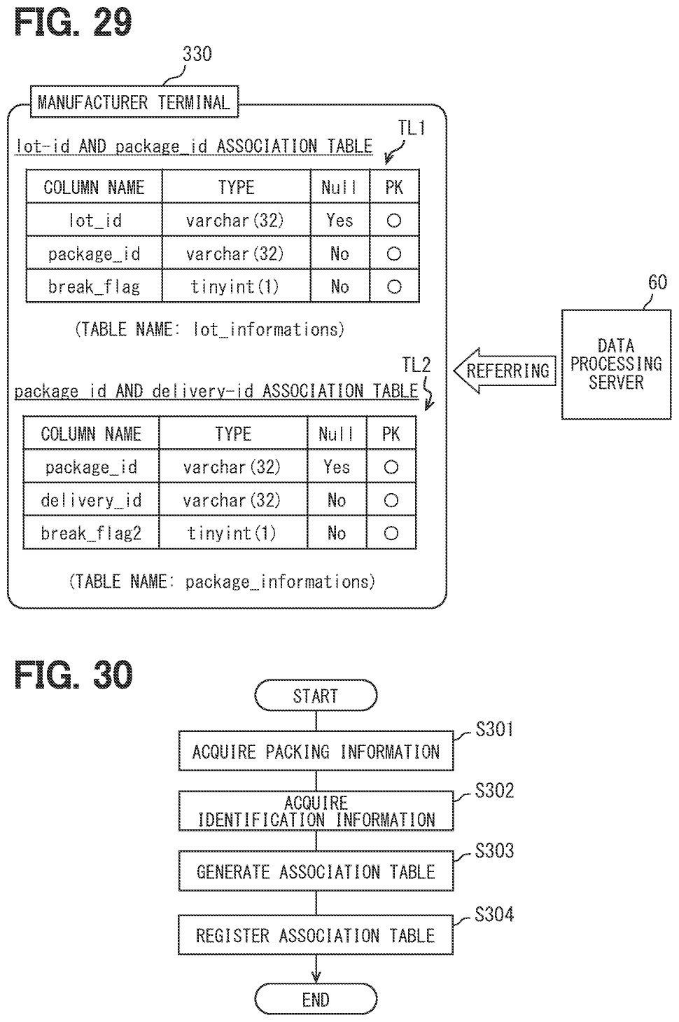

The manufacturer terminal 330 creates association tables TL1 and TL2 (see FIG. 29) as information for associating the relationship among the lot IM1, the package IM2, and the final product IMp for the cargo IMd shipped from the manufacturer DF. The manufacturer terminal 330 manages the association tables TL1 and TL2 and enables the data processing server 60 to refer to the association tables TL1 and TL2. The association table TL1 is a table that associates the lot ID for identifying the lot IM1 with the package ID for identifying the package IM2. The association table TL2 is a table that associates the package ID for identifying the package IM2 with the delivery ID for identifying the final product IMp.

In the association tables TL1 and TL2, a flag (hereinafter, a re-packaging flag) for recording whether the re-packaging has been performed is further set. When the re-packaging from the lot IM1 to the package IM2 is performed, a value of the re-packaging flag (see break flag in FIG. 29) in the association table TL1 is rewritten from “False” to “True”. In addition, when the re-packaging from the package IM2 to the final product IMp is performed, a value of the re-packaging flag (see break_flag2 in FIG. 29) in the association table TL2 is rewritten from “False” to “True”.

The manufacturer terminal 330 implements a table preparation processing (see FIG. 30) to prepare the association tables TL1 and TL2 for the cargo IMd shipped from the manufacturer DF so as to be referable from the data processing server 60. The table preparation processing is executed mainly by the processor 331 based on the information management program stored in the storage unit 333. The table preparation processing may be implemented before shipment of the cargo IMd or may be implemented in accordance with distribution of the cargo IMd.

In the table preparation processing, the manufacturer terminal 330 acquires packing information of the cargo IMd (S301). For example, the type of the packaging unit (category) of the cargo IMd to be shipped, the number of lower level packing units included in the upper-level packing unit, and the like are acquired as the packing information. The packing information may be information manually input by the staff member or the like of the manufacturing factory, or may be information received from a network of the manufacturing factory.

Based on the acquired packing information, the manufacturer terminal 330 acquires an item ID assigned as identification information to each packing unit, that is, the lot ID, the package ID, and the delivery ID (S302). These IDs may be generated by the manufacturer terminal 330, or may be generated by the data processing server 60 and provided to the manufacturer terminal 330.

The manufacturer terminal 330 generates association tables TL1 and TL2 (see FIG. 29) including the re-packaging flag by using the acquired IDs (S303). The manufacturer terminal 330 registers the generated association tables TL1 and TL2, for example, in the storage area of the storage unit 333 (S304). The association tables TL1 and TL2 may be uploaded to the data processing server 60.

The distributor terminal 340 and the monitoring device 20 are operated by the distributor LG and the re-packaging vendor WS. The distributor terminal 340 may be a fixed terminal installed in each site TB (see FIG. 2) of the distributor LG and the re-packaging vendor WS, or may be a mobile terminal such as the user terminal 110. Similar to the staff terminal 40 (see FIG. 1) of the first embodiment, the distributor terminal 340 implements the cargo receiving processing (see FIG. 6), the freezer association processing (see FIG. 7), the site processing (see FIG. 8), the cargo delivery processing to the next step (see FIG. 8), and the like.

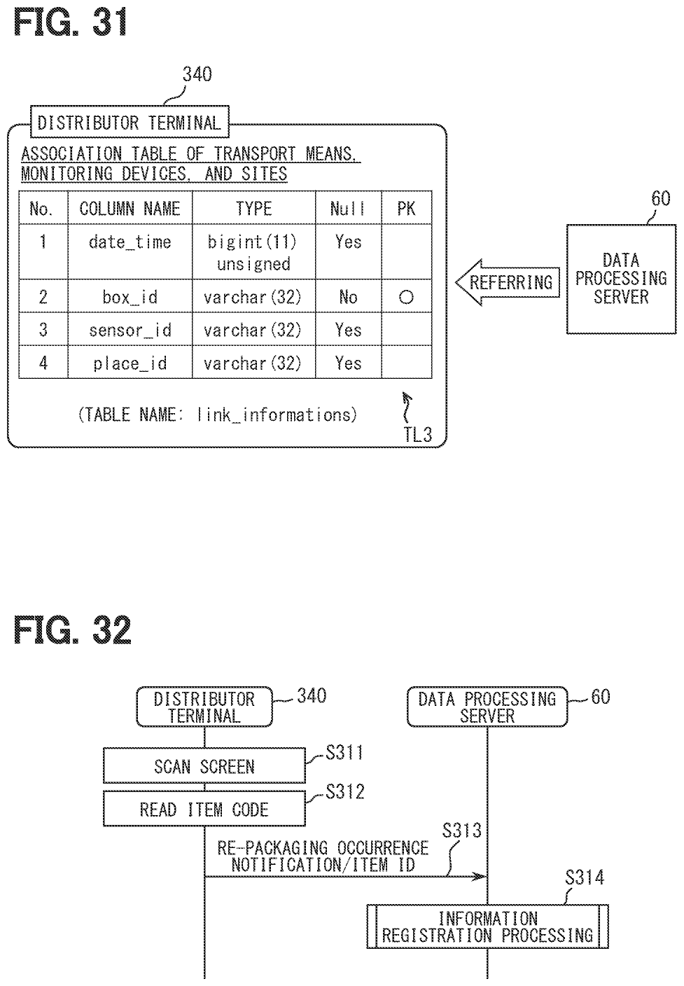

The distributor terminal 340 records an association table TL3 (see FIG. 31) for associating the transport means TP or the freezer 10 (see FIG. 2), the monitoring device 20, and the site TB according to the distribution of the cargo IMd on the basis of the above processing. The association table TL3 stores a box ID for identifying the freezer 10, a sensor ID for identifying the monitoring device 20, a place ID for identifying the site TB, and the like. The association table TL3 is referred to by the data processing server 60, for example, when the route display screen GA8, the temperature chart display screen GA9 (see FIG. 10), and the like are displayed on the user terminal 110.

When the cargo IMd is re-packaged, the distributor terminal 340 used by the re-packaging vendor WS implements a re-packaging notification processing (see FIG. 32) for notifying the data processing server 60 of the occurrence of re-packaging. The distributor terminal 340 displays the scan screen on the display (S311), and reads the item code Cd attached to the cargo IMd (S312). The distributor terminal 340 may read the item code Cd attached to the cargo IMd (the lot IM1 or the like) before re-packaging, or may read the item code Cd attached to the cargo IMd (the package IM2 or the like) after re-packaging. Furthermore, the distributor terminal 340 may read both item codes Cd.

The distributor terminal 340 transmits at least one of the lot ID, the package ID, and the delivery ID read from the item code Cd to the data processing server 60 together with a notification indicating occurrence of re-packaging (S313). The data processing server 60 acquires a notification and an ID transmitted by the distributor terminal 340 by reception, and registers them as occurrence information of re-packaging (S314). When acquiring the notification of occurrence of re-packaging, the data processing server 60 may refer to the association tables TL1 and TL2 recorded in the manufacturer terminal 330 and confirm consistency of information before and after re-packaging.

Here, in a case where re-packaging is performed as an actual operation in the distribution process, as described above, not only the method by which the user inputs that re-packaging has been performed to the distributor terminal 340, but also occurrence of re-packaging can be automatically registered. In the case of automatically registering the occurrence of re-packaging, the re-packaging notification processing can be shared with delivery information registration processing of registering delivery information of the cargo IMd in the data processing server 60. That is, only by reading the item code Cd of the cargo IMd using the distributor terminal 340, the data processing server 60 determines the presence or absence of re-packaging in the current step, and appropriately writes the occurrence information of re-packaging and the delivery information in the database.

In the re-packaging notification processing in which the occurrence information of re-packaging can be automatically registered, the user scans the item code Cd attached to the item after re-packaging using the distributor terminal 340 (S312). As described above, such work is the same as the work of registering the delivery information when no re-packaging is performed. The distributor terminal 340 transmits the item ID extracted from the item code Cd to the data processing server 60 (S313).

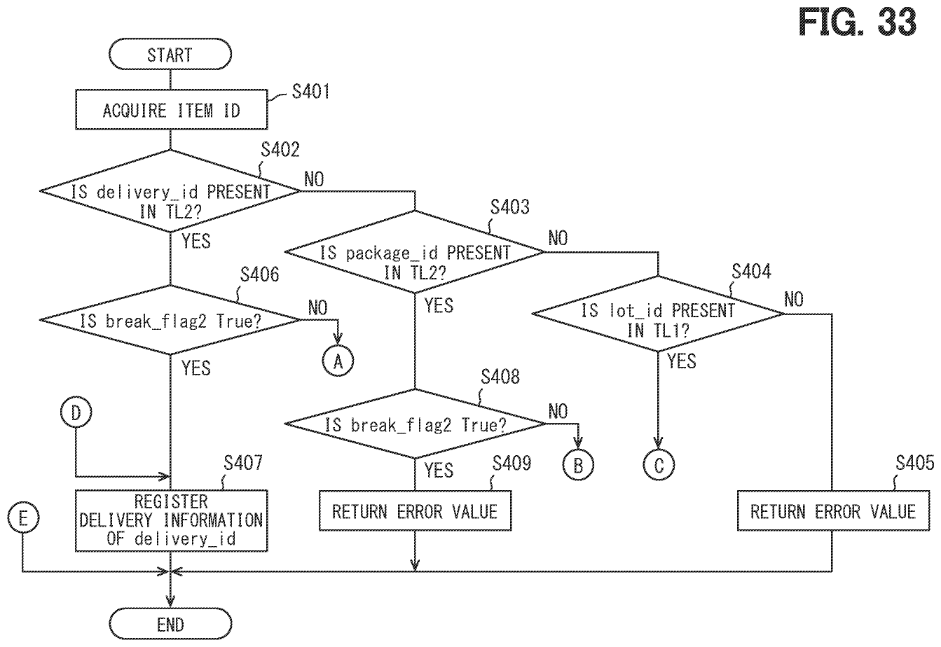

Upon receiving the item ID transmitted by the distributor terminal 340, the data processing server 60 implements an information registration processing (S314, see FIGS. 33 to 35). When acquiring the item ID (S401), the data processing server 60 refers to the association tables TL1 and TL2 (see FIG. 29) and searches for the acquired ID.

The data processing server 60 refers to the association table TL2 and determines whether a delivery ID corresponding to the acquired item ID exists in the association table TL2 (S402). When the delivery ID has been searched (S402: YES), the data processing server 60 confirms the value of the re-packaging flag (see FIG. 29 break_flag2) in the association table TL2 (S406). When the value of the re-packaging flag is “True” (S406: YES), that is, when re-packaging from the package IM2 to the final product IMp has been implemented by the time of the preceding step, the delivery information of the current step is registered in association with the delivery ID (S407).

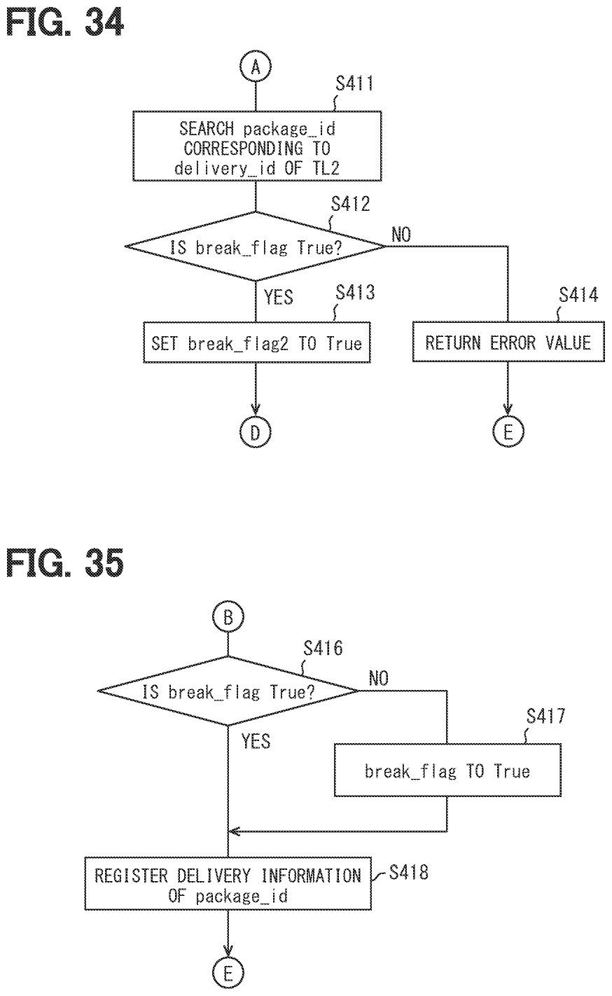

On the other hand, when the value of the re-packaging flag is “False” (S406: NO), the data processing server 60 searches the association table TL2 for the package ID corresponding to the delivery ID (S411 in FIG. 34). The data processing server 60 further refers to the association table TL1 in which the searched package ID is recorded, and confirms the value of the re-packaging flag (see break flag in FIG. 29) of the association table TL1 (S412). When the value of the re-packaging flag is “True” (S412: YES), the data processing server 60 determines that the re-packaging from the package IM2 to the final product IMp has been performed in the current step. In this case, the data processing server 60 registers the occurrence information of the re-packaging by rewriting the value of the re-packaging flag in the association table TL2 to “True” (S413). As described above, the registration of the delivery information, each piece of measurement information, and the like associated with the package ID is invalidated thereafter. Furthermore, the data processing server 60 registers the delivery information of the current step in association with the delivery ID (S407).

On the other hand, when the value of the re-packaging flag is “False” (S412: NO), the data processing server 60 returns an error value to the distributor terminal 340 (S414). The distributor terminal 340 displays a message such as “Delivery information cannot be registered” on the basis of the received error value, and notifies that the delivery information of the final product IMp cannot be registered because the lot IM1 has not been re-packaged to the package IM2.

When the delivery ID has not been searched (S402: NO), the data processing server 60 determines whether the package ID corresponding to the item ID exists in the association table TL2 (S403). When the package ID is searched (S403: YES), the data processing server 60 checks the value of the re-packaging flag of the association table TL2 (S408). When the value of the re-packaging flag is “True” (S408: YES), the data processing server 60 returns an error value to the distributor terminal 340 (S409). The distributor terminal 340 notifies, based on the received error value, that the ID of the package IM2 has already been re-packaged to the final product IMp. Specifically, a message such as “This package has already been re-packaged” is displayed on the display.

On the other hand, when the value of the re-packaging flag is “False” (S408: NO), the data processing server 60 refers to the association table TL1 in which the package ID is recorded. Then, the data processing server 60 confirms the value of the re-packaging flag of the association table TL1 (S416 in FIG. 35). When the value of the re-packaging flag is “True” (S416: YES), the data processing server 60 registers the delivery information of the current step in association with the package ID (S418).

On the other hand, when the value of the re-packaging flag is “False” (S416: NO), the data processing server 60 determines that the re-packaging from the lot IM1 to the package IM2 has been performed in the current step. In this case, the data processing server 60 registers the occurrence information of re-packaging by rewriting the value of the re-packaging flag in the association table TL1 to “True” (S417). As described above, the registration of the delivery information, each piece of measurement information, and the like associated with the lot ID is invalidated thereafter. Furthermore, the data processing server 60 registers the delivery information of the current step in association with the package ID (S418).

When both the delivery ID and the package ID have not been searched (S403: NO), the data processing server 60 determines whether the lot ID corresponding to the item ID exists in the association table TL1 (S404). When the lot ID has not been searched (S404: NO), the data processing server 60 returns an error value to the distributor terminal 340 (S405). The distributor terminal 340 displays a message such as “Invalid item code” on the basis of the received error value and notifies that the read item code Cd is invalid.

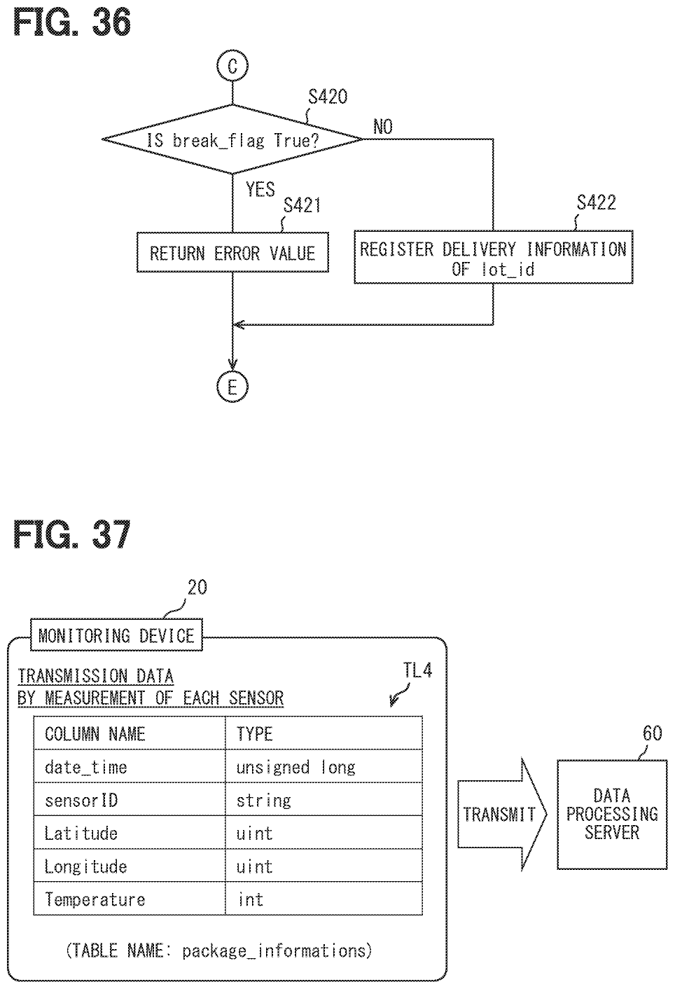

On the other hand, when the lot ID is searched from the association table TL1 (S404: YES), the data processing server 60 confirms the value of the re-packaging flag of the association table TL1 (S420 in FIG. 36). When the value of the re-packaging flag is “True” (S420: NO), the data processing server 60 returns an error value to the distributor terminal 340 (S421). The distributor terminal 340 notifies, on the basis of the received error value, that the ID of the lot IM1 has already been re-packaged to the package IM2. Specifically, a message such as “This lot has already been re-packaged” is displayed on the display. On the other hand, when the value of the re-packaging flag is “False” (S420: NO), the data processing server 60 registers the delivery information of the current step in association with the lot ID (S422).

Similar to the first embodiment, the monitoring device 20 periodically transmits the temperature measurement information and the position measurement information to the data processing server 60 sequentially or at regular time intervals. Measurement data TL4 (see FIG. 37) transmitted by the monitoring device 20 includes values such as measurement time, sensor ID, latitude, longitude, and temperature.

Similar to the first embodiment, the data processing server 60 is a server device managed by the platformer PF of the cold chain management system together with the time stamp server 140 and the application distribution server 150. The data processing server 60 can communicate with a large number of manufacturer terminals 330, a large number of distributor terminals 340, and a large number of monitoring devices 20 through the network. Also in the third embodiment, the front server 70, the information relay server 80, the blockchain server 90, and the like are provided as the data processing server 60, but details thereof are substantially the same as those in the first embodiment and are omitted, and will be described below as processing of the data processing server 60.

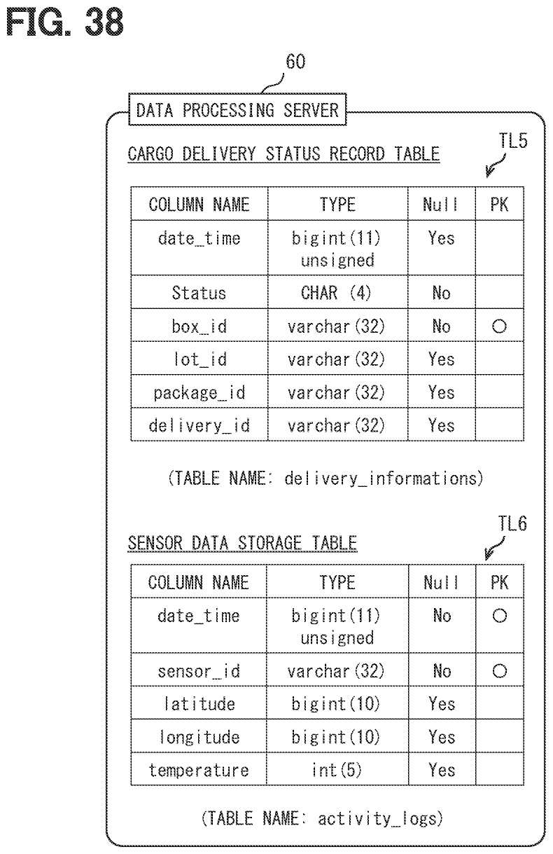

The data processing server 60 accumulates information transmitted from the manufacturer terminal 330, the distributor terminal 340, and the monitoring device 20 in association with the blockchain BC. The data processing server 60 creates a delivery status record table TL5 and a sensor data storage table TL6 as tables for recording the history information (transaction record, delivery information) of the cargo IMd (see FIG. 38). In the delivery status record table TL5, time information, the box ID, the lot ID, the package ID, the delivery ID, and the like are recorded. Similar to the association tables TL1 and TL2 (see FIG. 29), the delivery status record table TL5 may be used as information for associating the relationship among the lot IM1, the package IM2, and the final product IMp. In the sensor data storage table TL6, values such as measurement time, sensor ID, latitude, longitude, and temperature are recorded, similar to the measurement data TL4 (see FIG. 37) transmitted from the monitoring device 20.

In the cold chain management system described above, before occurrence of re-packaging, the monitoring device 20 is associated with the cargo IMd (for example, the lot IM1) before re-packaging in the freezer association processing (see FIG. 7). As a result, as described above, the data processing server 60 stores the temperature measurement information and the position measurement information received from the monitoring device 20 in association with the item ID (for example, the lot ID) of the cargo IMd before re-packaging. The temperature measurement information and the position measurement information correspond to “first item information” associated with the item before re-packaging, and are stored in association with the blockchain BC as in the first embodiment.

On the other hand, after the occurrence of re-packaging, the monitoring device 20 is associated with each of the plurality of cargos IMd (for example, the package IM2) after re-packaging in the freezer association processing (see FIG. 7). As a result, the data processing server 60 associates the temperature measurement information and the position measurement information received from the plurality of monitoring devices 20 with the item ID (for example, the package ID) of each cargo IMd after re-packaging. The temperature measurement information and the position measurement information correspond to the “second item information” associated with the item after re-packaging, and are individually stored in association with the blockchain BC, similar to the first item information. The blockchain BC used to store the second item information may be the same as or different from the blockchain BC used to store the first item information.

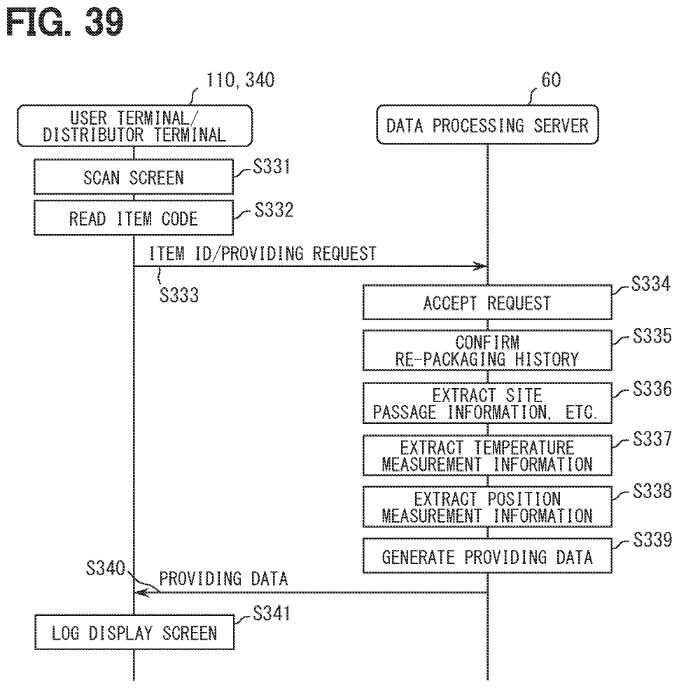

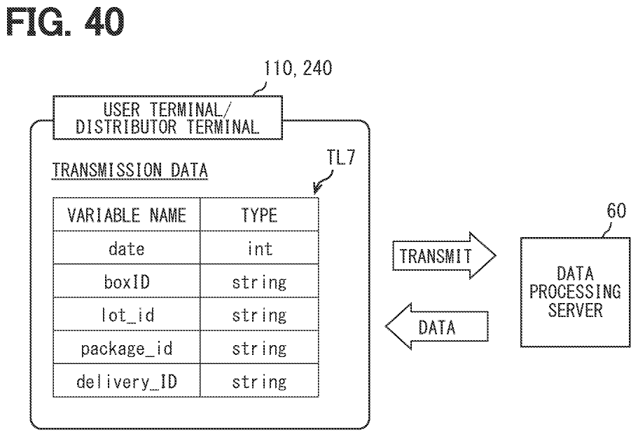

Next, details of information providing processing of providing history information (transaction record) of the cargo IMd accumulated in the cold chain management system to the user term inal 110 or the distributor term inal 340 (hereinafter, the terminal 110, 340) will be described below on the basis of FIG. 39 and with reference to FIGS. 28 and 40. The information providing processing is implemented by the terminal 110, 340 in which the log browsing application APb distributed by the application distribution server 150 is installed in advance and the data processing server 60.

The terminal 110, 340 displays the scan screen GA6 (see FIG. 10) on the display on the basis of the startup operation of starting the log browsing application APb by the user (S331). The terminal 110, 340 reads the item code Cd (see FIG. 26) attached to the final product IMp on the scan screen GA6, and acquires the item ID such as the delivery ID (S332). The item code Cd to be read on the scan screen GA6 may be attached to the lot IM1 or the package IM2. The terminal 110, 340 transmits transmission data TL7 (see FIG. 40) including the acquired item ID to the data processing server 60 together with the providing request of the history information associated with the item ID (cargo IMd) (S333).

The data processing server 60 acquires the providing request of the history information from the terminal 110, 340 by reception, and receives the providing request (S334). The data processing server 60 confirms a re-packaging history for the cargo IMd indicated by the acquired item ID. The data processing server 60 determines whether the cargo IMd is a cargo IMd after re-packaging that has been divided into a plurality of distribution units in the distribution process (S335). The data processing server 60 may confirm the presence or absence of the re-packaging history with reference to the delivery status record table TL5 (see FIG. 38), or may confirm the presence or absence of the re-packaging history with reference to the association tables TL1 and TL2 (see FIG. 29) recorded in the manufacturer terminal 330.

In a case where it is determined that no re-packaging has occurred in the cargo IMd, the data processing server 60 extracts the item information associated with the received item ID, specifically, the site passage information, the temperature measurement information, and the position measurement information by search (S336 to S338). Similar to the first embodiment, the processing of extracting each item information may be implemented by the coordination of the front server 70, the information relay server 80, the blockchain server 90, and the like (see FIG. 11). The data processing server 60 combines the site passage information, the temperature measurement information, and the position measurement information to generate providing data to be provided to the terminal 110, 340 (S339).

On the other hand, in a case where there is the re-packaging history, the data processing server 60 extracts the item IDs associated with each other on the basis of the information of each table, and grasps the anteroposterior relationship of re-packaging. Specifically, when the item ID is the delivery ID, the package ID and the lot ID are read. When the item ID is the package ID, the lot ID is read. The data processing server 60 extracts the item information associated with each ID by search (S336 to S338). Specifically, all the item information associated with the delivery ID, the item information associated with the package ID, and the item information associated with the lot ID are extracted. The data processing server 60 combines the item information associated with each ID to generate providing data to be provided to the terminal 110, 340 (S339). Specifically, a series of history information from the shipment from the manufacturer DF to the end user EU is generated by connecting the item information before and after re-packaging in time series.

The data processing server 60 provides the generated providing data to the terminal 110, 340 by transmission (S340). As described above, the terminal 110, 340 displays the log display screen such as the list display screen GA7, the route display screen GA8, and the temperature chart display screen GA9 on the display (S341).

As in the third embodiment described above, even in a case where re-packaging occurs in the distribution process, if the information associated with the cargo IMd is stored in association with the blockchain BC, the same effects as those of the first embodiment are obtained, and the falsification risk of the information can be reduced.

In addition, also in the third embodiment, the site passage information, the temperature measurement information, and the position measurement information having different data measurement cycles are individually stored in different blockchains BC. Therefore, the same effects as those of the first embodiment are obtained, and the searchability of the accumulated information is improved, so that the convenience of the information can be secured.

In addition, in the third embodiment, in the distribution step in which the packing unit does not change, the packing unit is set as a management unit, so that an increase in the data amount of the accumulated item information can be suppressed. As a result, since the amount of data written to the blockchain BC can also be suppressed, it is possible to increase the speed of processing required for information management.

Furthermore, in the third embodiment, the association tables TL1 and TL2 for associating an item before re-packaging such as the lot IM1 and an item after re-packaging such as the package IM2 are referred to, and information associated with the item before re-packaging is acquired together with information associated with the item after re-packaging. Then, information associated with each item is combined to generate providing data to be provided to the requesting source of the providing request. As described above, with the setting of the association tables TL1 and TL2, even in a case where re-packaging occurs, the association of the item information before and after the re-packaging can be reliably implemented. Therefore, even if the amount of accumulated data is suppressed, the history information can be referred back to the upstream of the distribution step.

In addition, in the third embodiment, the data processing server 60 automatically determines the occurrence of re-packaging on the basis of the acquired item ID. Therefore, the occurrence information of re-packaging can be registered in the association tables TL1 and TL2 without relying on the operation of the user of the distributor terminal 340, in other words, the staff member of the re-packaging vendor WS. As a result, it is possible to accumulate the delivery information of the cargo IMd without omission while improving the efficiency of the re-packaging operation on site.

In the third embodiment, the association tables TL1 and TL2 and the delivery status record table TL5 correspond to “association information”. In addition, when the lot IM1 is divided into the packages IM2, the lot IM1 corresponds to the “item before re-packaging”, and the package IM2 corresponds to the “item after re-packaging”. Similarly, in a case where the package IM2 is divided into the final product IMp, the package IM2 corresponds to the “item before re-packaging”, and the final product IMp corresponds to the “item after re-packaging”.

Each of the embodiments described above further discloses the following technical features 1 to 7.

Technical Feature 1

An information management program that is implemented by a computer (60) and manages information, wherein the information management program causes at least one processor (61) to execute processing including: acquiring a plurality of pieces of item information having different data input or data measurement cycles as information associated with a specific item (IMs) (S26, S27, S37, S226, S227); and individually storing the plurality of pieces of item information associated with the specific item in association with a plurality of different blockchains (BC) (S28, S29, S38, S228, S229).

Technical Feature 2

An information management program that is executed by a computer (60) and manages information related to a distribution item (IMd), wherein the information management program causes at least one processor (61) to execute processing including: acquiring temperature measurement information repeatedly measured by a temperature sensor (21) associated with the distribution item (S26); acquiring position measurement information repeatedly measured by a position sensor (22) associated with the distribution item (S27); and storing the temperature measurement information and the position measurement information in association with at least one blockchain (BC) (S28, S29).

Technical Feature 3

An information management program that is executed by a computer (60) and manages information related to an item, wherein the information management program causes at least one processor (61) to execute processing including: acquiring usage amount information indicating a usage amount of power or an energy resource used in association with at least one of manufacturing and distribution of the item (S214, S226); and storing the usage amount information for each type of the power and the energy resource in association with at least one blockchain (BC) as the information related to the item (S215, S226).

Technical Feature 4

An information management program that is executed by a computer (60, 330) and manages information related to a distribution item (IMd) in which occurrence of re-packaging for dividing into a plurality of distribution units is assumed in a distribution process, wherein the information management program causes at least one processor (61, 331) to execute processing including: preparing association information (TL1, TL2, TL5) for associating an item before re-packaging that is the distribution item before the occurrence of re-packaging with an item after re-packaging that is the distribution item after the occurrence of re-packaging (S303, S304); in a state before the occurrence of re-packaging, storing first item information associated with the item before re-packaging in association with a blockchain (BC) (S28, S29); and in a state after the occurrence of re-packaging, individually storing second item information associated with each of the plurality of items after re-packaging in association with the blockchain (S28, S29).

Technical Feature 5

An information providing program that is executed by a computer (60) and provides information managed by using a plurality of blockchains (BC), wherein the information providing program causes at least one processor (61) to execute processing including: acquiring a providing request of information associated with a specific item (IMs) (S114); acquiring specific first information associated with the specific item from first information managed by a first blockchain (BC2) (S120); acquiring specific second information associated with the specific item from second information managed by a second blockchain (BC3) different from the first blockchain (S123); and generating providing data to be provided to a requesting source of the providing request by combining the specific first information and the specific second information (S124).

Technical Feature 6

An information providing program that is executed by a computer (60) and provides information managed by using a blockchain (BC), wherein the information providing program causes at least one processor (61) to execute processing including: acquiring usage amount information indicating a usage amount of power or an energy resource used in relation to manufacturing and distribution of an item, the usage amount information being managed by the blockchain (BC) for each type of the power and the energy resource (S269, S271); and preparing a calculation method corresponding to a destination set for the item, and calculating a carbon release amount of the item from the usage amount information for each type using the calculation method (S272, S273).

Technical Feature 7

An information providing program that is executed by a computer (60) and provides information managed by using a blockchain (BC), wherein the information providing program causes at least one processor (61) to execute processing including: acquiring a providing request of information associated with a distribution item (IMd) (S334); in a case where the distribution item is an item after re-packaging that has been divided into a plurality of distribution units in a distribution process, referring to association information (TL1, TL2, TL5) that associates the item before re-packaging that is before being divided into the plurality of distribution units with the item after re-packaging (S335); acquiring first item information associated with the item before re-packaging from the information managed using the blockchain together with second item information associated with the item after re-packaging (S336 to S338); generating providing data to be provided to a requesting source of the providing request by combining the first item information and the second item information (S339).

### OTHER EMBODIMENTS

Although the plurality of embodiments of the present disclosure have been described above, the present disclosure is not to be construed as being limited to the above-described embodiments, and can be applied to various embodiments and combinations without departing from the gist of the present disclosure.

In the first embodiment, the temperature measurement information and the position measurement information associated with the cargo IMd are managed using the blockchain BC. However, the plurality of pieces of measurement information managed using the blockchain BC is not limited to the temperature measurement information and the position measurement information. A plurality of pieces of measurement information having different measurement cycles or acquisition cycles may be separately managed using a plurality of blockchains BC.

As an example, an information management system of a first modification is used as an education management system that records a daily learning time of a student and a test grade (score) as measurement information associated with the student. As another example, an information management system of a second modification is used as an agricultural management system that records the amount of water and the amount of fertilizer applied to crops as measurement information associated with crops. The information accumulated in the agricultural management system can be provided to consumers of crops.

As another example, the information management system according to the second modification is applied to a supply chain constructed by a plurality of suppliers similar to the second embodiment. The information management system according to the second modification functions as a supply chain management system that manages a transaction record of an item implemented between suppliers. The site terminal 30 of the second modification is installed in a site of each supplier, and records delivery of an item from another supplier and shipment of an item to another supplier as site information. Specifically, the site terminal 30 records a site ID for identifying a site of each supplier, an item ID, a delivery time and a shipment time of an item, and the like as the site information. In addition, the site terminal 30 may record processing information, assembly information, processing information, and the like implemented by each supplier as the site information. The site terminal 30 transmits the site information recorded by manual input or automatic input to the server device. In the second modification, the site of the supplier corresponds to the “relay site”.

In a third modification of the above embodiment, one item information of the site passage information, the temperature measurement information, and the position measurement information is excluded from the target to be stored in the blockchain BC. As an example, only the temperature measurement information and the position measurement information among the three item information are stored in association with the blockchain BC.

The information management system according to a fourth modification of the second embodiment is used for calculating all carbon emission amounts related to items distributed in the market as products. More specifically, the information management system is applied to a recording system that records an emission amount (so-called carbon footprint) of a greenhouse gas such as carbon dioxide in the manufacture and life cycle of a specific item.

In the fourth modification, a carbon emission amount (hereinafter, an in-manufacturing emission amount) generated by manufacturing or processing of one item (product) is grasped for each site of each supplier included in the supply chain. The in-manufacturing emission amount per item is, for example, a value obtained by dividing the total carbon emission amount emitted at the site at the time of production, processing, or the like by the number of items produced at the site.

Furthermore, a carbon emission amount (hereinafter, an in-distribution emission amount) generated for distributing one item is grasped for each movement of the item between the supplier sites. As an example, the in-distribution emission amount per item is calculated using the total carbon emission amount required for movement between sites, the movement distance and weight of the item, and the like. A calculation processing of the in-manufacturing emission amount and the in-distribution emission amount may be performed by the site terminal 30 or may be performed by any server device.

Furthermore, the in-manufacturing emission amount and the in-distribution emission amount are acquired in the front server 70 as a plurality of pieces of “item information” having different input or measurement cycles, and are individually stored in association with a plurality of different blockchains BC. For example, the in-manufacturing emission amount is stored in an in-manufacturing emission amount keeping chain and the in-distribution emission amount is stored in an in-distribution emission amount keeping chain. Then, based on the providing request, the carbon emission amount per one item is provided to the requesting source as providing data by an integration processing of combining the in-manufacturing emission amount and the in-distribution emission amount.

In addition, the carbon emission amount generated with the disposal or recycling of the item may be further stored as the item information in the blockchain BC different from the in-manufacturing emission amount keeping chain and the in-distribution emission amount keeping chain. In the fourth modification, the in-manufacturing emission amount corresponds to the “first information” and the “specific first information”, and the in-manufacturing emission amount keeping chain corresponds to the “first blockchain”. In addition, the in-distribution emission amount corresponds to the “second information” and the “specific second information”, and the in-distribution emission amount keeping chain corresponds to the “second blockchain”.

The information management system according to a fifth modification of the second embodiment is used for management of a battery mounted on a vehicle (xEV) using an electric motor as at least a part of a power source for traveling. For example, the information management system enables management of production of raw materials of batteries, production of battery cells, use in the market, and recycling and reuse after the end of service life in the market on the basis of the EU battery instruction. Specifically, not only the source of cathode materials such as cobalt, nickel, lithium, manganese, and aluminum, but also environmental and health performances can be managed by the information management system.

Furthermore, the carbon footprint information (numerical value) provided by the supply chain management system can be used as data that serves as a basis for calculating the border carbon tax rate. The information management system according to the present disclosure is not limited to industrial products such as the battery BAT, and can guarantee a carbon footprint from manufacturing and distribution for items such as steel, cement, fertilizer, and aluminum.

In the above embodiment, the cooler box ID also functions as the sensor ID for identifying the monitoring device 20. On the other hand, in a sixth modification of the above embodiment, the cooler box ID and the sensor ID are separately recorded. In the sixth modification, the staff terminal 40 performs a registration processing of associating the cooler box ID with the sensor ID. Furthermore, in a seventh modification of the above embodiment, the cargo IMd and the monitoring device 20 are distributed integrally, so that the item ID also serves as the sensor ID.

In an eighth modification of the above embodiment, the type information of the road is used as the transport information. Specifically, in a case where the controller 23 determines that the vehicle is moving using the expressway, the controller 23 reduces the acquisition frequency of the position measurement information to suppress the amount of data accumulated in the position information keeping chain BC3. According to the above, even if the interval between the measurement points Pd is wide, the same transport route TR as the actual movement trajectory can be reproduced on the route display screen GA8.

In the above embodiment, the measurement cycle of the temperature measurement information and the position measurement information is controlled by the controller 23. On the other hand, in a ninth modification of the above embodiment, the front server 70 controls the measurement cycle. The front server 70 may transmit a command instructing the measurement cycle to the controller 23, and may control the measurement cycle (sampling cycle) on the recording by adjusting the thinning of the measurement information transmitted from the monitoring device 20. Furthermore, in a tenth modification of the above embodiment, the function of adjusting the measurement cycle of the position measurement information is omitted. In an eleventh modification, the function of adjusting the measurement cycle of the temperature measurement information is omitted.

In the cold chain management system according to the above embodiment, the temperature measurement information and the position measurement information are managed using different blockchains BC. On the other hand, in the cold chain management system according to a twelfth modification of the above embodiment, the temperature measurement information and the position measurement information are stored in association with one blockchain BC. Furthermore, the measurement cycle of the temperature information and the measurement cycle of the position information may be appropriately set. For example, the measurement cycle of the temperature information can be set longer than the measurement cycle of the position information. Furthermore, the measurement cycle of the temperature information can be set to be shorter than the measurement cycle of the position information.

The hash function used by each of the information storing units 92, 95, and 98 of each blockchain server 90 may be appropriately changed. The hash function has a characteristic that the same hash value is not output from different inputs, and it is substantially impossible to estimate an input from the output hash value. With such characteristics, for example, encryption algorithms such as SHA-256, SHA-1, SHA-2, and SHA-3 may be appropriately used according to a required output length (number of bits).

Each of the information providing units 93, 96, and 99 of each blockchain server 90 may have a function of verifying the extracted data. As an example, each of the information providing units 93, 96, and 99 executes computation using the hash function at a timing of providing the history information associated with the item ID. According to such a verification processing, the history information verified not to be falsified is provided to the end user EU or the like.

In a thirteenth modification example of the above embodiment, the item ID, the cooler box ID, and the like are recorded using the above-described RFID technology. In the data recording medium attached to the distribution item as in the thirteenth modification, an RFID tag may be used instead of the one-dimensional code or the two-dimensional code printed on the paper medium. According to the use of such an RFID technology, for example, even in a state where the RFID tag is not visually recognized, the item ID and the cooler box ID can be remotely read. Note that, in the thirteenth modification, the staff terminal 40 and the user terminal 110 are connected to a reader or the like capable of reading the RFID tag in a wired or wireless manner. In addition, a one-dimensional code or a two-dimensional code may be used in a part of the cold chain CC, and the RFID tag may be used in another part.

Furthermore, an aspect of the information code used for the item code Cd or the like may be appropriately changed. For example, a secure QR code (SQRC, registered trademark) capable of setting disclosure and non-disclosure of recorded information by using an encryption key may be used as the item code Cd. Furthermore, the two-dimensional code may be a color QR code or the like including information that can be read only by a specific reading device, or may be a two-dimensional code that can be read by irradiation with infrared rays or ultraviolet rays.

In the above embodiment and modifications, the respective functions provided by the data processing server 60 can be also provided by software and hardware for executing the software, only software, only hardware, or any combinations of software and hardware. Furthermore, the respective functions provided by the staff terminal 40 and the user terminal 110 can be also provided by software and hardware for executing the software, only software, only hardware, or any combinations of software and hardware. In cases where these functions are provided by electronic circuits as hardware, the functions can be also provided by analog circuits or digital circuits that include a large number of logic circuits.

In the foregoing embodiments, the processor may include at least one operational core, such as a central processing unit (CPU) or a graphics processing unit (GPU). The processor may further include a field-programmable gate array (FPGA) and an IP core having other dedicated functions.

The form of storage medium (non-transitory tangible storage medium) adopted as a storage unit of the above embodiments and storing each program related to the information management method of the present disclosure may be properly changed as appropriate. For example, the storage medium is not limited to the configuration provided on the circuit board, and may be provided in a form of a memory card or the like. For example, the storage medium may be inserted into a slot, and electrically connected to a bus of computer. The storage medium may include an optical disk which provides a source of programs to be copied into a computer, a hard disk drive therefor, or the like.

The controllers and methods thereof described in the present disclosure may be implemented by a special purpose computer which includes a processor programmed to execute one or more functions implemented by computer programs. Alternatively, the device and the method described in the present disclosure may be implemented by a special purpose hardware logic circuit. Alternatively, the device and the method described in the present disclosure may be implemented by one or more special purpose computers, which are configured as a combination of a processor executing a computer program and one or more hardware logic circuits. The computer programs may also be stored in a computer readable non-transitory tangible storage medium as computer-executable instructions.

1. An information management method, implemented by a computer, for managing information, the method comprising:
acquiring a plurality of pieces of item information having different data input cycles or data measurement cycles as information associated with a specific item; and
individually storing each of the plurality of pieces of item information associated with the specific item in association with a plurality of different blockchains.

2. An information management method, implemented by a computer, for managing information related to a distribution item, the method comprising:
acquiring temperature measurement information repeatedly measured by a temperature sensor associated with the distribution item;
acquiring position measurement information repeatedly measured by a position sensor associated with the distribution item; and
storing the temperature measurement information and the position measurement information in association with at least one blockchain.

3. The information management method according to claim 2, further comprising:
acquiring site information related to passage of the distribution item through a relay site, and
storing the site information in association with the at least one blockchain.

4. The information management method according to claim 1, wherein
the plurality of pieces of item information includes temperature measurement information repeatedly measured by a temperature sensor associated with a distribution item as the specific item and position measurement information repeatedly measured by a position sensor associated with the distribution item, and
storing the plurality of pieces of item information further includes:
storing the temperature measurement information in association with a temperature information keeping chain that is one of the plurality of different blockchains; and
storing the temperature measurement information in association with a position information keeping chain that is one of the plurality of different blockchains different from the temperature information keeping chain.

5. The information management method according to claim 4, wherein
the plurality of pieces of item information further includes site information related to passage of the distribution item through a relay site, and
storing the plurality of pieces of item information further includes storing the site information in association with a site information keeping chain that is one of the plurality of different blockchain different from both the temperature information keeping chain and the position information keeping chain.

6. The information management method according to claim 2, wherein
re-packaging for dividing the distribution item into a plurality of distribution units is assumed to occur in a distribution process,
the method further includes:
before the re-packaging occurs, storing, in association with the at least one blockchain, the temperature measurement information and the position measurement information measured by the temperature sensor and the position sensor, respectively, associated with a pre-repackaging item that is the distribution item before the re-packaging, and
after the re-packaging occurred, individually storing, in association with the at least one blockchain, the temperature measurement information and the position measurement information measured by the temperature sensor and the position sensor, respectively, associated with each of a plurality of post-repackaging items which are the distribution item after the re-packaging.

7. The information management method according to claim 2, further comprising changing a measurement cycle of the position measurement information based on transport information related to transportation of the distribution item.

8. The information management method according to claim 7, further comprising
shortening a measurement cycle of the position measurement information as a transportation speed of the distribution item increases.

9. The information management method according to claim 7, further comprising
changing a measurement cycle of the position measurement information depending on a type of a transport facility for transporting the distribution item.

10. The information management method according to claim 2, further comprising
changing a measurement cycle of the temperature measurement information based on form information related to a form of the distribution item.

11. The information management method according to claim 10, further comprising
extending a measurement cycle of the position measurement information as a surface area relative to a volume of the distribution item decreases.

12. An information management method, implemented by a computer, for managing information related to an item, the method comprising:
acquiring usage amount information indicative of a usage amount of power or an energy resource used in association with at least one of manufacturing and distributing of the item; and
storing the usage amount information for each type of the power and the energy resource in association with at least one blockchain as the information related to the item.

13. The information management method according to claim 12, wherein
acquiring usage amount information further includes acquiring production place information indicative of a production place of the energy resource, and
storing usage amount information further includes storing the usage amount information of the energy resource in association with the production place information.

14. An information management method, implemented by a computer, for managing information related to a distribution item in a distribution process where re-packaging for dividing the distribution item into a plurality of distribution units is assumed to occur, the method comprising:
preparing association information for associating a pre-repackaging item that is the distribution item before the re-packaging with post-repackaging items that are the distribution item after the re-packaging;
before the re-packaging occurs, storing first item information associated with the pre-repackaging item in association with a blockchain; and
after the re-packaging occurred, individually storing second item information associated with each of the plurality of post-repackaging items in association with the blockchain.

15. An information providing method, implemented by a computer, for providing information managed by using a plurality of blockchains, the method comprising:
acquiring a providing request for information associated with a specific item;
acquiring specific first information associated with the specific item from first information managed by a first blockchain;
acquiring specific second information associated with the specific item from second information managed by a second blockchain different from the first blockchain; and
generating providing data to be provided to a requesting source of the providing request by combining the specific first information and the specific second information.

16. The information providing method according to claim 15, wherein
the specific first information and the specific second information are measurement information having different measurement cycles, and
generating the providing data further includes generating the providing data by combining the specific first information and the specific second information depending on each measurement cycle.

17. The information providing method according to claim 16, wherein
the information associated with a distribution item is managed in the plurality of blockchains, and
the specific second information includes position measurement information measured by a position sensor associated with the distribution item in a transportation period of time during which the distribution item moves between relay sites.

18. The information providing method according to claim 17, further comprising
acquiring specific site information related to passage of the distribution item through the relay site among from site information managed by a third blockchain different from the first blockchain and the second blockchain, wherein
generating the providing data further includes generating the providing data by complementing a space between at least two pieces of site position data recorded in the site information with in-transport position data during the transportation period of time recorded in the position measurement information.

19. The information providing method according to claim 17, further comprising:
acquiring position data of the requesting source as delivery location information; and
transmitting an arrival advance notification to the requesting source when the distribution item is determined to approach the requesting source based on comparison between current position information measured by the position sensor and the delivery location information.

20. An information providing method, implemented by a computer, for providing information managed by using a blockchain, the method comprising:
acquiring usage amount information indicative of a usage amount of power or an energy resource used in relation to manufacturing and distributing of an item, the usage amount information being managed by the blockchain for each type of the power and the energy resource;
preparing a calculation method in accordance with a destination set for the item; and
calculating, using the prepared calculation method, a carbon release amount of the item from the usage amount information for each type of the power and the energy.

21. The information providing method according to claim 20, wherein
acquiring the usage amount information further includes acquiring the usage amount information associated with production place information indicative of a production place of the used energy resource, and
calculating the carbon release amount further includes calculating the carbon release amount reflecting the production place information.

22. The information providing method according to claim 20, wherein
calculating the carbon release amount further includes, when the destination is not set for the item, calculating the carbon release amount using the calculation method that is provisionally set.

23. An information providing method, implemented by a computer, for providing information managed by using a blockchain, the method comprising:
acquiring a providing request for information associated with a distribution item;
when the distribution item are post-repackaging items that have been divided into a plurality of distribution units in a distribution process, referring to association information that associates a pre-repackaging item that is the distribution item before being divided into the plurality of distribution units with the post-repackaging items;
acquiring first item information associated with the pre-repackaging item from the information managed using the blockchain together with second item information associated with the post-repackaging items; and
generating providing data to be provided to a requesting source of the providing request by combining the first item information and the second item information.
